(19) United States
(12) Patent Application Publication
(10) Pub. No.: US 2025/0018500 A1
(43) Pub. Date: Jan. 16, 2025

(54) LASER ABLATION SYSTEM WITH CONFIGURABLE LASER BEAM

(71) Applicant: Cory Holliman, Prairie Hill, TX (US)

(72) Inventor: Cory Holliman, Prairie Hill, TX (US)

(21) Appl. No.: 18/767,419

(22) Filed: Jul. 9, 2024

Related U.S. Application Data
(60) Provisional application No. 63/525,858, filed on Jul. 10, 2023.

(51) Int. Cl. B23K 26/03; B08B 7/00; B23K 26/00

(52) U.S. Cl. CPC B23K 26/03; B08B 7/0042; B23K 26/0096

(57) ABSTRACT

The laser ablation system utilizes a variety of configurable laser beams to remove a substance from the surface of a substrate without damaging the underlying substrate. The present invention implements improvements to the laser ablation system to provide a gentle, yet thorough, ablating system through the use of a variety of rotating patterns. Furthermore, the system of the present invention is highly modifiable, such that a wide variety of parameters are adjustable to accommodate a wide variety of cleaning jobs.

### CROSS-REFERENCE TO RELATED APPLICATIONS

This application is related to and claims priority from the following US patents and patent applications: this application claims priority from and the benefit of U.S. Provisional Patent Application No. 63/525,858, filed Jul. 10, 2023, which is incorporated herein by reference in its entirety.

### BACKGROUND OF THE INVENTION

### 1. Field of the Invention

The present invention relates to a laser cleaning system, and more specifically to a highly adjustable laser ablation system that utilizes a laser beam in various configurations to clean a substrate without damaging the surface of the substrate.

### 2. Description of the Prior Art

It is generally known in the prior art to provide a cleaning method utilizing laser ablation

Prior art patent documents include the following:

U.S. Pat. No. 5,780,806 for Laser ablation system, and method of decontaminating surface by inventors Ferguson, et al., filed Jul. 25, 1995 and issued Jul. 14, 1998, is directed to a laser ablation system comprising a laser head providing a laser output; a flexible fiber optic cable optically coupled to the laser output and transmitting laser light; an output optics assembly including a nozzle through which laser light passes; an exhaust tube in communication with the nozzle; and a blower generating a vacuum on the exhaust tube. A method of decontaminating a surface comprising the following steps: providing an acousto-optic, Q-switched Nd:YAG laser light ablation system having a fiber optically coupled output optics assembly; and operating the laser light ablation system to produce an irradiance greater than 1×10 7 W/cm 2, and a pulse width between 80 and 170 ns.

U.S. Pat. No. 6,794,602 for Method and apparatus for cleaning generator and turbine components by inventors Nair, et al., filed Oct. 18, 2001 and issued Sep. 21, 2004, is directed to a method and apparatus for cleaning a generator or turbine component using a laser ablation technique. The method includes programming a controller coupled to a laser source for controlling the laser source to perform laser ablation. A laser beam is directed at a generator or turbine component surface for vaporizing surface contaminants and coatings deposited on the generator or turbine component surface without changing material properties of said generator or turbine component. A computer system having a processor and a database is communicatively coupled to the controller. The database is loaded with turbine or generator component data and corresponding laser power related data for ablating surface contaminants and coatings from respective components. The apparatus also includes a detector disposed adjacent to the turbine or generator component to monitor ablation process and provide feedback data to the computer system, and a comparator for comparing the feedback data with predetermined data to determine progress of ablation. The laser source is controlled to produce a laser beam depending on the comparison step.

U.S. Pat. No. 6,693,255 for Laser ablation cleaning by inventors Freiwald, et al., filed Mar. 14, 2022 and issued Feb. 17, 2004, is directed to a laser ablation cleaning apparatus. An optical box containing mirrors for specially directing laser light, such as repeated pulsed CO₂ laser, is mounted in a hand-held cleaning head or in a custom work head. The hand-held cleaning head can be used to safely direct laser energy to a surface to be cleaned; the laser beam ablates from the surface coatings, corrosion, and the like without harming the substrate. The custom work head is removably mountable upon the iron core stack of a conventional commercial electric generator, and features an optics box carriage that is selectively movable along the axis of the stack to direct a laser beam into the slots of the stack for cleaning.

U.S. Pat. No. 8,330,073 for Method and device for laser ablation of a surface coating from a wall, such as a coat of paint in a nuclear plant by inventors Champonnois, et al., filed May 18, 2006 and issued Dec. 11, 2012, is directed to a method for laser ablation of a surface coating from a wall, such as a painted wall finish, for example in a nuclear plant to be decontaminated, and a device for implementing said method. The inventive ablation method includes sweeping shots on the coating of at least one pulsed laser beam with a laser beam quality factor M² less than 20, and characterized in that it comprises a direct control of said shots by optical deflection, such that the impact zones (I1, I2, I3,) of said shots on said coating are disjointed or substantially adjacent with minimized overlapping.

U.S. Pat. No. 10,702,895 for Processing tool cleaning using laser ablation by inventors Tracey, et al., filed Jun. 5, 2018 and issued Jul. 7, 2020, is directed to molds, comprising non-metal base portions and protective optical layers that cover and shield these base portions from laser ablation. For example, a protective optical layer may reflect a laser beam used for ablating the mold. Methods of forming these protective optical layers on non-metal base portions are also provided. In some embodiments, this protective optical layer is the outermost layer exposed to the environment. Alternatively, the protective optical layer may be covered by a release layer. The release layer may be retained or removed during laser ablation. In some embodiments, light emitted by a mold during laser ablation is analyzed to determine performance of its protective optical layer. This feedback may be used to control the laser ablation such as to control orientation of the laser beam relative to the mold.

US Patent Publication No. 2019/0126328 for Optimized-coverage selective laser ablation systems and methods by inventors Barclay, et al., filed Oct. 27, 2017 and published Aug. 18, 2020, is directed to Optimized-coverage selective laser ablation systems and methods may be utilized to prepare (ablate) a three-dimensional surface. Methods comprise receiving a 3D virtual model of the surface to be ablated, generating a preliminary ablation path, and optimizing the preliminary ablation path to produce an adapted ablation path. Methods may comprise ablating the surface according to the adapted ablation path. The preliminary ablation path may be based on scanning a laser sheet across a two-dimensional projection of the surface. The optimization may adjust one or more waypoints of the preliminary ablation path to achieve complete coverage of the surface at acceptable levels of ablation, with little to no ablation outside the surface, and with acceptable (e.g., at least locally minimal) time to ablate the surface.

U.S. Pat. No. 11,047,017 for Laser ablation devices that utilize beam profiling assemblies to clean and process surfaces by inventor Dajnowski, filed Apr. 13, 2018 and issued Jun. 29, 2021, is directed to laser ablation devices that utilize beam profiling assemblies to clean and process surfaces are described herein. A method includes directing a laser beam in a geometrical pattern at an arcuate surface of a cylindrical target, blocking a portion of the laser beam to prevent a portion of the geometrical pattern from contacting the cylindrical target, and rotating the cylindrical target as the laser beam contacts the arcuate surface so as to ablate the cylindrical target.

US Patent Publication No. 2019/0275568 for Large-area selective ablation systems by inventor Barclay, filed May 23, 2019 and published Apr. 14, 2020, is directed to a laser ablation system comprises a laser, a scanning head, a laser-positioning apparatus, and a controller. The laser is configured to emit a laser beam. The scanning head is configured to deliver the laser beam onto a surface. The laser-positioning apparatus is configured to adjust relative positions of the surface and the scanning head. The controller is programmed to determine operation parameters such as a traverse scan speed, a laser-beam average power, a laser pulse repetition rate, a laser pulse width, and a laser-beam spot area for each one of scan regions of an area of the surface. The scan regions are arranged so that all of the area of the surface is scannable with the laser beam. The scan width of at least one of the scan regions is different from the scan width of another one of the scan regions.

US Patent Publication No. 2021/0362270 for Laser ablation and laser processing fume and contaminant capture system by inventors Dajnowski, filed May 18, 2021 and published Nov. 25, 2021, is directed to Laser ablation and laser processing fume and contaminant capture systems. An example system includes a housing forming a partial enclosure that is configured to be placed against a target surface, a transparent window being integrated into a top surface of the housing, the transparent window being configured to allow for the transmission of a laser scan pattern to the target surface, and an outlet port for establishing a negative pressure inside the housing. Air is drawn into the housing through a first inlet port, the air carries contaminants created during ablation of the target surface by the laser scan pattern out of the outlet port.

U.S. Pat. No. 10,744,539 for Optimized-coverage selective laser ablation systems and methods by inventors Barclay, et al., filed Oct. 27, 2017 and issued Aug. 18, 2020, is directed to optimized-coverage selective laser ablation systems and methods utilized to prepare (ablate) a three-dimensional surface. Methods comprise receiving a 3D virtual model of the surface to be ablated, generating a preliminary ablation path, and optimizing the preliminary ablation path to produce an adapted ablation path. Methods may comprise ablating the surface according to the adapted ablation path. The preliminary ablation path may be based on scanning a laser sheet across a two-dimensional projection of the surface. The optimization may adjust one or more waypoints of the preliminary ablation path to achieve complete coverage of the surface at acceptable levels of ablation, with little to no ablation outside the surface, and with acceptable (e.g., at least locally minimal) time to ablate the surface.

U.S. Pat. No. 10,618,083 for Large-area selective ablation systems by inventor Barclay, filed May 23, 2019 and issued Apr. 14, 2020, is directed to a laser ablation system comprises a laser, a scanning head, a laser-positioning apparatus, and a controller. The laser is configured to emit a laser beam. The scanning head is configured to deliver the laser beam onto a surface. The laser-positioning apparatus is configured to adjust relative positions of the surface and the scanning head. The controller is programmed to determine operation parameters such as a traverse scan speed, a laser-beam average power, a laser pulse repetition rate, a laser pulse width, and a laser-beam spot area for each one of scan regions of an area of the surface. The scan regions are arranged so that all of the area of the surface is scannable with the laser beam. The scan width of at least one of the scan regions is different from the scan width of another one of the scan regions.

US Patent Publication No. 2023/0191462 for Laser cleaning apparatus and method by inventor Clowes, filed May 21, 2021 and published Jun. 22, 2023, is directed to Laser cleaning apparatus (100) comprising: a laser system (102) configured to output laser light having a power, a wavelength, a temporal characteristic and a divergence; a delivery cable (106) to deliver the laser light to a cleaning head; a cleaning head (110) comprising: an output aperture and output optics (116) configured to focus the laser light (104) to have a fluence at a focal plane (126) that is greater than an ablation threshold of a surface contaminant to be removed from a surface to be cleaned; scanning apparatus (118) to scan the laser light in at least one dimension across a scan region within the focal plane to cause the scanning laser light to have an effective divergence greater than the divergence of the laser light and to have a corresponding safe working distance from the output aperture determined by the effective divergence, the power, the wavelength and the temporal characteristic; and scan monitoring apparatus (120) to monitor the effective divergence of the scanning laser light and to generate an alarm signal (108) in response to determining that the effective divergence has changed.

US Patent Publication No. 2006/0213615 for Laser nozzle cleaning tool by inventor Rastegar, filed Dec. 16, 2005 and published Sep. 28, 2006, is directed to an apparatus including a laser operating in different cleaning techniques is provided. In one embodiment, the laser interacts with the particle to remove the particle by expansion. In another embodiment, a liquid-assisted laser cleaning technique evaporates a liquid layer on the surface by laser pulses and subsequently removing the particles from the surface. Further, the present disclosure provides parameters to control the energy transfer to the particle. For example, for a shock wave generation parameters, the droplets size and concentration (e.g., pressure), substrate surface temperature, chemical composition of the droplets may be controlled.

U.S. Pat. No. 10,968,562 for Methods and apparatus for laser cleaning of fabric materials by inventor Clowes, filed May 6, 2019 and issued Apr. 6, 2021, is directed to methods and apparatus for cleaning a substrate, such as a fabric material, involving the application of optical energy to the substrate, typically in the form of a beam of light, where the energy of the beam causes removal of the contaminant from substrate, such as from the fibres of a fabric material. The cleaning may occur via any mechanism, including one or more of, alone or in any combination, ablation, melting, heating or reaction with the substrate or contaminant or agent introduced to aid in the cleaning. The optical energy is typically applied to a selected area of the substrate (e.g., as a beam), and the substrate and beam or optical energy source moved relative to one another so as to clean a larger area of the substrate, either by moving the substrate or the beam, or both. Movement of the beam with respect to the substrate can be attained through a beam scanning mechanism or through movement of the optical source itself.

U.S. Pat. No. 8,628,624 for Laser cleaning of components by inventors Turner, et al., filed Jul. 27, 2007 and issued Jan. 14, 2014, is directed to a method and system for removing substances from a surface, in which the surface is irradiated by high-energy laser radiation, characterized in that the laser parameters are chosen to selectively remove one or more predetermined substances from the surface without removing other substances from the surface.

US Patent Publication No. 2020/0001393 for Handheld pulsed laser device for cleaning or treating a surface by inventor Philippron, filed Sep. 3, 2019 and published Jan. 2, 2020, is directed to a method for using the pulsed laser cleaning device during cleaning or treating of a surface.

US Patent Publication No. 2022/0118486 for Laser system for non-contact and selective removal of corrosion from tubes internal surfaces by inventor Mattar, filed Oct. 20, 2020 and published Apr. 21, 2022, is directed to an automated or manual laser ablation system and method of use to enable safe, non-user-contact, rapid, and remote cleaning of industrial tubular equipment, e.g. heat-exchangers and reactors. The laser ablation system comprises: a fiber optic cable (12) with a laser probe output end (20), connected to an optics unit (5 or 6) enclosed within a laser probe housing (14). The optics unit comprises: a double convex and/or one or two plano-convex lens; and an Axicon prism, mirror cone, and/or galvo-scanning mirror to emit a rotating or a fixed circular beam. The laser beam cleans a plurality of reactor tubes' internal wall to cause the evaporation of deposit buildups and rust. The laser ablation system further comprises: an air vacuum system (30) positioned to cool the ablation system while removing the debris to a vacuum generator (35); and/or a push motor (60) that pushes and pulls the system through the tubes.

US Patent Publication No. 2022/0184736 for Laser system and methods for containing a laser beam and manufacturing a laser containment apparatus by inventors Cardon, et al., filed Jul. 15, 2021 and published Jun. 16, 2022, is directed to a laser system includes a controller, a laser source, a laser scanner, and a laser containment apparatus. The laser containment apparatus includes a mounting structure for the laser scanner, a shroud assembly coupled to the mounting structure, and a seal interface coupled to the shroud assembly at an opposite end from the laser scanner. The shroud assembly surrounds a working volume of the laser scanner and includes a vacuum port connected to a vacuum source and a purge port that guides purge gas from a purge gas source toward the laser scanner. A distal end of the seal interface is formed of a pliable material that compresses to seal the shroud assembly to a target surface of a workpiece upon establishment of a negative pressure differential between a vacuum pressure inside the shroud assembly and ambient atmospheric pressure.

U.S. Pat. No. 6,114,651 for Laser beam apparatus and workpiece machining process by inventors Schluter, et al., filed Nov. 26, 1997 and issued Sep. 5, 2020, is directed to a laser beam apparatus for the removal of surface layers from work pieces with a beam-emitting head that may be guided by hand and that is equipped with focusing optics, which is connected to laser apparatus that generates a laser beam so as to admit light, which exhibits a beam-deflecting direction that moves on a pre-determined pathway in an oscillating manner, which covers the laser beam radially with a point and releases it through an emission opening that faces the work piece, and which has a distance retainer that permits the adjustment of the distance of the beam-emitting head from the work piece. In order to achieve the possibility of its use under freehand guidance with great mean power outputs in the course of which acceptable area coverage rates, or rather processing times are to be rendered possible, the laser beam apparatus is embodied in such a way that the distance retainer is the point of the beam-emitting head that covers the laser beam radially, that the laser beam may be oscillated by the beam deflection apparatus on a pre-determined pathway by means of an exit opening of the distance retainer that has been adapted to the pathway, and that the focusing optics can alter the focusing of the laser beam depending upon the beam deflection in the sense of a focus that lies on the surface of the work piece.

US Patent Publication No. 2023/0074954 for Laser treatment device and procedure for laser treatment by inventors Cretskens, et al., filed Jul. 22, 2022 and published Mar. 9, 2023, is directed to a laser treatment head comprising an input for a laser bundle, and further provided with a lens system for focusing the laser bundle and a scanning system for deflecting the laser bundle according to a one-dimensional or two-dimensional touch pattern. In particular, the laser treatment head further comprises an directional body configurable relative to the casing between at least a first position and a second position, for variably emitting the deflected laser bundle with said touch pattern, in at least a first or a second emission direction. In further aspects, the invention relates to a laser treatment device and a laser treatment process.

CN Patent No. 207,447,601 for A kind of laser cutting head automatic focusing structure by inventors Yuan Zhonghui, et al., filed Nov. 20, 2017 and issued Jun. 5, 2018, is directed to laser cutting head automatic focusing structure, the focusing barrel including mounting shell and in mounting shell; Mounting shell outer surface is provided with adjusting cover, and the stepper motor for adjusting screw and driving adjusting screw is provided in adjusting cover; Focusing barrel outer surface is fixed with adjustment sheet; The adjusting straight slot of adjustment sheet is provided on mounting shell; The feed screw nut for adjusting screw snaps connection with adjustment sheet; Adjust the connection plug for being provided on cover and being electrically connected with stepper motor; It during adjusting, is electrically connected by connection plug and stepper motor, driving stepper motor adjusts screw and drives focusing barrel longitudinal movement, and automation control is easy to adjust; Adjustment sheet is connected installation with focusing barrel, adjusts screw and is snapped connection with adjustment sheet, adjusts cover and is fixedly mounted with mounting shell, assembling is very convenient.

CN Patent No. 207,447,646 for A kind of laser cutting head dustproof constructions by inventors Yuan Zhonghui, et al., filed Nov. 20, 2017 and issued Jun. 5, 2018, is directed to a kind of laser cutting head dustproof construction, including collimator, collimation microscope group, focusing microscope group and the nozzle set gradually; Dust preventing component is both provided between collimator and collimation microscope group and between focusing microscope group and nozzle; Dust preventing component includes installation link block, and installation link block one side is provided with the dust-proof drawer of drawing and pulling type, and dust-proof eyeglass is provided on dust-proof drawer and installs the first through hole of dust-proof eyeglass; The second through hole corresponding with first through hole is provided on installation link block; By setting two groups of dust preventing components, ensure that light beam is dustless during output is linked into, improve light beam convergence rate; It is designed by drawing and pulling type, it is simple in structure convenient for safeguarding and assembling production, it is at low cost.

CN Patent No. 112,589,269 for Parameter visualization handheld laser welding gun and assembly method by inventors Yuan Zhonghui, et al., filed Dec. 24, 2020 and published Apr. 2, 2021, is directed to a parameter visualization handheld laser welding gun and an assembly method, wherein the parameter visualization handheld laser welding gun comprises a gun head part, a handheld part and a display assembly; set up the incident light passageway that supplies laser to pass through in the handheld portion, set up in the rifle head with incident light passageway complex emergent light passageway, the one end that deviates from its laser outgoing on the rifle head is equipped with the installation position of installation display module, set up the trough in the handheld portion, the trough communicates with the installation position, through encapsulating display module in the protection casing, fixes the protection casing on the rifle head again, when operating personnel welded, can master the degree of closing of welding parameter and actual welding condition in real time.

CN Patent No. 112,643,202 for Handheld laser welding gun and assembly method thereof by inventors Yuan Zhoghui, et al., filed Jan. 6, 2021 and published Apr. 13, 2021, is directed to a hand-held laser welding gun and an assembly method thereof, comprising a welding gun body, wherein the welding gun body is provided with a gun head part, a hand-held part and a connecting part for connecting the hand-held part and the gun head part; the welding gun comprises a welding gun body, and is characterized in that a light path channel penetrating from a handheld part to a gun head part is arranged in the welding gun body, a water inlet and a water outlet are arranged on a connecting part, a water conveying channel is arranged on the connecting part corresponding to the water inlet and the water outlet, a water returning channel communicating the water conveying channels corresponding to the water inlet and the water outlet respectively is arranged on a gun head part, the water conveying channels corresponding to the water inlet and the water outlet respectively and the water returning channels frOm a circulating water cooling channel, a wiring groove penetrating through two ends of the handheld part is arranged in the handheld part, and the water inlet and the water outlet are opposite to the wiring groove.

CN Patent No. 207,447,644 for A kind of laser cutting head plug quick connection structure by inventors Yuan Zhoghui, et al., filed Nov. 20, 2017 and issued Jun. 5, 2018, is directed to laser cutting head plug quick connection structure, the light source connector including light source collimator and connection light source line; Light source joint surface has multiple first raised lines close to end set; Multiple first raised lines are uniformly distributed in a ring in light source joint surface; The turning set that light source joint surface is provided with annular groove and is rotated in annular groove; It is provided on turning set and one-to-one second raised line of the first raised line; Light source collimator inner surface is provided with the slot for the first raised line and the insertion of the second raised line; Slot two side is respectively arranged with the first buckling groove corresponding with the first raised line and the second buckling groove corresponding with the second raised line; After light source connector fixed laser cable, by the first raised line and the second raised line alignment insertion light source collimator, it is rotated after being inserted into position, first raised line is caught in the first buckling groove, then reversely rotate turning set, second raised line is caught in the second buckling groove, and the reliability being connected can also be ensured by twisting situation occur with light source collimator even if light source connector.

CN Patent No. 207,447,630 for A kind of laser cutting head focus lamp adjustment structure by inventors Yuan Zhoghui, et al., filed Nov. 20, 2017 and issued Jun. 5, 2018, is directed to a kind of laser cutting head focus lamp adjustment structure, including laser focus pack; Laser focus pack includes focusing on microscope group and installation focuses on the mounting shell of microscope group; Installation side surfaces are provided with the mounting hole of adjusting knob and installation and adjustment knob; Adjusting knob includes dial and rotation cam It focuses on microscope group outer surface and is fixed with adjustment sheet, the transverse concave groove adjusted with rotation cam engagement is provided on adjustment sheet; In use, by rotation of adjustment knob, rotation angle is marked in dial, and rotation cam lobe position squeezes one inner wall of groove, keeps position after adjusting by stiction after adjusting, reaches adjusting purpose, and overall structure is simple, and assembling is easy to adjust, at low cost.

CN Patent No. 207,447,645 for A kind of laser cutting head temperature testing organization by inventors Yuan Zhoghui, et al., filed Nov. 20, 2017 and issued Jun. 5, 2018 is directed to a kind of laser cutting head temperature testing organization, the nozzle chamber including nozzle and installation nozzle; Further include the connector of connection nozzle and nozzle chamber; Longitudinally connected hole is provided on connector; Upper end of nozzle is provided with the connecting tube being connected with connecting hole; Connecting seat and light hole corresponding with connecting hole are provided on nozzle chamber; The connector sleeve being connected with connecting seat is provided on connector; Connector lower end is provided with the temperature sensor being close to nozzle; During assembling, nozzle chamber and nozzle are connected by connector, being bonded nozzle by the temperature sensor on connector carries out it temperature detection, and Detection accuracy is high, easy for installation, and replacement is easy to maintain, simple in structure, at low cost.

CN Patent No. 207,337,600 for A kind of laser cutting head collimation adjustment structure by inventors Yuan Zhoghui, et al., filed Nov. 20, 2017 and issued Jun. 5, 2018, is directed to a kind of laser cutting head collimation adjustment structure, including collimation microscope group and mounting cylinder; Mounting cylinder is provided with the through hole of installation collimation microscope group; Be provided in through hole be adjacent to collimation microscope group outer surface can deformation part; The adjusting knob on two abutting collimating mirror group surfaces is provided on mounting cylinder; Two adjusting knobs are in vertical distribution; Collimation microscope group outer surface is pushed against by the adjusting knob of two vertical distributions, form a rectangular coordinate system, when needing to adjust, rotation of adjustment knob squeeze collimation microscope group so that can deformation part deformation, adjustable extent be 360 degree, adjustable range is wide, adjustment structure is simple, and adjusting is very convenient, and holistic cost is low.

CN Patent No. 207,447,602 for A kind of laser cutting head collimator longitudinal adjusting mechanism by inventors Yuan Zhoghui, et al., filed Nov. 20, 2017 and issued Jun. 5, 2018, is directed to laser cutting head collimator longitudinal adjusting mechanisms, and microscope group and mounting shell are collimated including light source; The longitudinally mounted hole of installation light source collimation microscope group is provided on mounting shell; Light source collimation microscope group outer surface is fixed with longitudinally guiding item; Inner wall of the hole installing is provided with the guide groove with gib block cooperation; Installation side surfaces are provided with the through hole of connection guide groove, are rotated in through hole and are provided with adjusting rod, adjusting rod is provided with adjustment gear towards guide groove one end; Gib block side wall is provided with rack corresponding with adjustment gear; Laser cutting head collimator longitudinal adjusting mechanism further includes regulation handle and the friction top to compressing positioning after adjusting rod adjusting for adjusting that adjusting rod rotates; Adjusting rod end set has the adjusting blind hole convenient for adjusting; Friction top is fixed with mounting shell by screw rod, and is provided with flexible glue block on one side towards blind hole is adjusted; It is easy to adjust, it is not easy to shift, good integrity is simple in structure, at low cost.

CN Patent No. 208,644,377 for A kind of automatic focusing mechanism for laser cutting by inventors Yuan Zhoghui, et al., filed Aug. 9, 2018 and issued Mar. 26, 2019, is directed to a kind of automatic focusing mechanisms for laser cutting, including the first mounting shell and the second mounting shell being fixedly connected with the first mounting shell, setting first is open on first mounting shell, and setting is open with the second of the first opening cooperation on the second mounting shell; Focus lamp is set in the first mounting shell, connecting plate is set in the second mounting shell, focus lamp includes interconnecting piece, and connecting plate passes through the second opening and the first opening is connect with interconnecting piece; The sliding block being fixedly connected with connecting plate is also set up in second mounting shell; Further include stepper motor, screw rod is also set up in the second mounting shell, screw rod is connect by shaft coupling with stepper motor; Screw rod includes nut and screw rod, and sliding block is fixedly connected with screw rod; The sliding rail parallel with screw rod is also set up in second mounting shell, connecting plate is slidably connected with sliding rail. Constantly change focal position, realizes automatic focusing, the cutting effect got well.

CN Patent No. 208,853,929 for A kind of automatic focusing mechanism for laser cutting by inventor Yuan Zhoghui, et al., filed Aug. 9, 2018 and issued May 14, 2019, is directed to a kind of automatic focusing mechanisms for laser cutting, including the first mounting shell and the second mounting shell being fixedly connected with the first mounting shell, stepper motor is fixedly connected on second mounting shell, the outer surface of the first mounting shell is equipped with display circuit module; Display module includes single-chip microcontroller, and single-chip microcontroller is electrically connected with the controller of stepper motor, and single-chip microcontroller is electrically connected with three or eight decoders and priority encoder, and three or eight decoders are electrically connected with four seven segment digital tubes, and priority encoder is electrically connected with four yards of seven segment digital tubes; It is communicated by the controller of the stepper motor on the second mounting shell with single-chip microcontroller, the binary coding of single-chip microcontroller is converted into output signal and shows data for four seven segment digital tubes by three or eight decoders and priority encoder; Display circuit module, which is located to easily facilitate on the first mounting shell, checks data; Realize that real-time display cuts distance, small in size, structure is simple, at low cost.

WIPO Patent Publication No. 2022/147688 for Handheld laser beam welding gun and assembly method therefor by inventors, Yuan Zhoghui, et al., filed Jan. 6, 2021 and published Jul. 14, 2022, is directed to a handheld laser beam welding gun and an assembly method therefor, the handheld laser beam welding gun comprising a welding gun body, wherein the welding gun body is provided with a gun head portion, a handheld portion, and a connecting portion for connecting the handheld portion and the gun head portion. The welding gun body is internally provided with an optical path channel that passes through same from the handheld portion to the gun head portion. The connecting portion is provided with a water inlet and a water outlet, and the connecting portion is provided with water conveying channels corresponding to the water inlet and the water outlet. The gun head portion is provided with a water return channel that is in communication with the water conveying channels that respectively correspond to the water inlet and the water outlet. The water conveying channels, which respectively correspond to the water inlet and the water outlet, and the water return channel form a circulating water cooling channel. The handheld portion is internally provided with a wiring passage passing through both ends thereof, and both the water inlet and the water outlet directly face the wiring passage.

WIPO Patent Publication No. 2022/133840 for Parameter-visual handheld laser welding gun and assembly method by inventors Yuan Zhoghui, et al., filed Dec. 24, 2020 and published Jun. 30, 2022, is directed to a parameter-visual handheld laser welding gun and an assembly method. The parameter-visual handheld laser welding gun comprises a gun head portion, a handheld portion and a display assembly, wherein an incident light channel for laser light to pass through is provided in the handheld portion; an emergent light channel matching the incident light channel is provided in the gun head portion; a mounting position for mounting the display assembly is arranged at one end of the gun head portion that faces away from laser light emission thereof; and a wiring groove is provided in the handheld portion, and is in communication with the mounting position.

CN Patent No. 216,796,289 for Multifunctional welding gun with variable welding surface light spot by inventors Yuan Zhoghui, et al., filed Dec. 31, 2021 and issued Jun. 10, 2022, is directed to a welding surface facula variable multifunctional welding gun, which comprises a welding gun body, wherein the welding gun body comprises a gun head part, a handheld part and a connecting part; the welding gun comprises a welding gun body, a connecting part, a cooling channel, a display screen, a parameter adjusting device, a gun head part, a gas blowing hole, a gas blowing protective mirror and a protective mirror drawer, wherein the welding gun body is internally provided with a light path channel, the connecting part is internally provided with an XY axis deflection mechanism for adjusting the emergent deflection angle of an incident light beam, the connecting part is provided with the cooling channel and the display screen convenient for observing welding parameters, the handheld part is provided with the parameter adjusting device for adjusting the welding parameters, the gun head part comprises a gun head body and a base, an electrostatic shielding layer is arranged between the gun head body and the base, the base is provided with the gas blowing hole, the base is also provided with the gas blowing protective mirror and the protective mirror drawer for preventing gas flow from flowing backwards, and the handheld part is also internally provided with a wire arranging channel; the utility model has compact integral structure, convenient and simple use, can realize the arbitrary switching of the point line surface processing modes, can cool the welding gun body, prolongs the service life and simultaneously can avoid the influence of static electricity on internal devices.

CN Patent No. 216,066,010 for Air flue structure of hand-held laser welding gun by inventors Yuan Zhoghui, et al., filed Nov. 5, 2021 and issued Mar. 18, 2022, is directed to an air flue structure of a handheld laser welding gun, which comprises a welding gun body and a sealing element, wherein the welding gun body comprises a handheld part and a gun head part which are detachably connected, mutually communicated laser channels are respectively arranged in the handheld part and the gun head part, a cavity is also arranged in the handheld part along the length direction of the handheld part, an air channel communicated with the outside is arranged on the inner wall of the cavity, an air inlet channel is arranged on the gun head part corresponding to the air channel and is communicated with the laser channel in the gun head part, a protective mirror assembly is arranged in the gun head part, and the air inlet channel is positioned on one side of the protective mirror assembly, which is far away from the handheld part; the sealing element is detachably connected with the gun head part, and an air guide groove for communicating the air channel with the air inlet channel is arranged on the sealing element; the air channel is communicated with the air inlet channel through the air guide groove on the sealing piece, the cavity is matched to further realize air blowing inside air leakage, and the air pipe is prevented from being exposed to influence the normal work of the welding gun.

CN Patent No. 216,807,716 for Welding gun control circuit capable of realizing parameter adjustment and handheld welding gun by inventors Yuan Zhoghui, et al., filed Dec. 23, 2021 and issued Jun. 21, 2022, is directed to a welding gun control circuit capable of realizing parameter adjustment and a handheld welding gun, wherein the welding gun control circuit capable of realizing parameter adjustment comprises: the device comprises a control module, a data interface module and a knob coding module; the control module comprises a control unit and an online burning unit; the online burning unit is electrically connected with the control unit, and the data interface module and the knob coding module are electrically connected with the control unit; the control unit adjusts the parameters of the online burning unit by rotating the knob encoding module and then transmits the parameters to the host through the data interface module. The utility model can realize parameter adjustment and welding work simultaneously by only one person, and workers do not need to run back and forth between the main machine and the welding station, thereby improving the portability of parameter adjustment of the welding gun, reducing the working strength and improving the production efficiency.

CN Patent No. 216,177,591 for Handheld laser welding gun with quick-release type protective mirror module by inventors Yuan Zhoghui, et al., filed Oct. 25, 2021 and issued Apr. 5, 2022, is directed to a handheld laser welding gun with a quick-release type protective mirror module, which comprises a handheld part and a gun head part, wherein a drawer groove communicated with an internal optical channel of the gun head part is arranged on the gun head part; the drawer seat is provided with a through hole corresponding to the optical channel, the protective glasses are coaxially arranged in the through hole, two sides of the protective glasses are respectively provided with a first fastening piece and a second fastening piece for preventing the protective glasses from moving, the ends, which are deviated from each other, of the first fastening piece and the second fastening piece are respectively provided with an annular sealing table, and when the drawer seat is assembled in place, the annular sealing tables extend out of the through hole; this welding gun can dismantle the connection with protective glass and rifle head portion through the drawer subassembly, is convenient for tear open and trades, and overall structure is simple moreover, and maneuverability is strong.

CN Patent No. 214,382,982 for Hand-held type laser welding rifle by inventors Yuan Zhoghui, et al., filed Jan. 6, 2021 and issued Oct. 12, 2021, is directed to a hand-held laser welding gun, which comprises a welding gun body, wherein the welding gun body is provided with a gun head part, a hand-held part and a connecting part for connecting the hand-held part and the gun head part; this internal light path passageway that runs through to the rifle head from handheld portion that is equipped with of welding rifle, be equipped with water inlet and delivery port on the connecting portion, it is equipped with the fortune water passageway to correspond water inlet and delivery port respectively on the connecting portion, the fortune water passageway that water inlet and delivery port correspond respectively constitutes the circulating water cooling passageway with return water passageway, is equipped with the trough that runs through its both ends in the handheld portion, and water inlet and delivery port are all just to the trough, the utility model has the advantages of being simple in whole structure, constitute inside circulation water-cooling structure through fortune water passageway and return water passageway, can be quick cools off the welding rifle body, has protected the life-span of inside spare part, has prolonged the life of welding rifle, has improved operator's use comfort moreover.

CN Patent No. 216,576,063 for Adjusting lens group fixing structure of handheld laser welding gun by inventors Yuan Zhoghui, et al., filed Dec. 27, 2021 and issued May 24, 2022, is directed to a fixing structure of an adjusting lens group of a handheld laser welding gun, which comprises a welding gun body, wherein the welding gun body comprises a handheld part, a gun head part and a connecting seat for connecting the handheld part and the gun head part; an adjusting cavity for communicating a first light channel in the handheld part with a second light channel in the gun head part is arranged in the connecting seat; the adjusting cavity is at least internally provided with a deflectable reflector for adjusting the deflection angle of the light beam and at least one fixed reflector matched with the deflectable reflector to form a light reflecting path; be equipped with the installation position of the fixed speculum of installation on the inner wall of regulation chamber, be equipped with on the installation position and support the elasticity of fixed speculum on the installation position and support the piece, and then play just installation, just effect of dismantling makes the steadiness of fixed speculum obtain the guarantee simultaneously, and the fine condition of rocking of taking place for mirror group in having avoided the use takes place.

CN Patent No. 217,667,126 for handheld single pendulum formula laser welding rifle by inventors Yuan Zhoghui, et al., filed May 20, 2022 and issued Oct. 28, 2022, is directed to a hand-held single pendulum type laser welding gun, which comprises a gun head body and a handle body detachably connected with the gun head body; the welding gun comprises a gun head body, a handle body, a gun head body and a welding gun body, wherein an incident channel for laser beams to enter is arranged in the handle body, an emergent channel communicated with the incident channel is arranged in the gun head body corresponding to the incident channel, a reflector for reflecting the laser beams from the incident channel out of the emergent channel is arranged in the emergent channel, and the welding gun also comprises a driving mechanism for driving the reflector to swing; the driving mechanism is connected with an external power supply through the first electric contact terminal and the second electric contact terminal when the gun head body is assembled in place; the utility model has the advantages that the whole structure is compact, the dismounting and mounting are convenient, the welding process of point type and line type welding surface can be realized through the reflector that can deflect, and the function is powerful.

CN Patent No. 216,939,019 for Quick-release welding head structure of double-shaft oscillating type handheld laser welding gun by inventors Yuan Zhoghui, et al., filed Mar. 15, 2022, and issued Jul. 12, 2022, is directed to a quick-release welding head structure of a double-shaft swing type handheld laser welding gun, wherein the welding gun comprises a handheld part and a gun head part; the gun head part comprises a gun head seat and a gun barrel detachably connected with the gun head seat, an installation base station is convexly arranged on the gun head seat corresponding to the gun barrel, a gasket is arranged between the gun barrel and the installation base station, a first drawer groove, a second drawer groove and a third drawer groove which are communicated with an internal optical channel of the installation base station are arranged on the installation base station, a first drawer assembly for installing a first lens group is arranged in the first drawer groove, and a second drawer assembly for installing a second lens group is arranged in each of the second drawer groove and the third drawer groove; the first drawer groove, the second drawer groove and the third drawer groove are sequentially arranged along the light emitting direction of the light channel; the utility model has simple integral structure and convenient maintenance, and when the lens group on the gun head needs to be maintained and replaced, the lens group can be quickly and simply taken out only by taking the corresponding drawer component out of the drawer groove.

CN Patent No. 216,939,018 for Handheld wire feeding clamp for laser welding equipment by inventors Yuan Zhoghui, et al., filed Mar. 11, 2022 and ranted Jul. 12, 2022, is directed to a wire feeding clamp of handheld laser welding equipment, which comprises a wire feeding pipe and a fixed seat, wherein the wire feeding pipe is connected with the fixed seat through a wire feeding pipe; a through hole for the wire feeding pipe to pass through is arranged on the fixing seat in a penetrating manner, one end of the wire feeding pipe is positioned in the through hole, the other end of the wire feeding pipe is provided with a guide end cap for preventing the welding wire from deflecting, a locking piece for fixing the wire feeding pipe in the through hole is arranged on the fixing seat, an observation window communicated with the through hole is arranged on the fixing seat, and the observation window is arranged along the axial direction of the through hole; the fixed seat is also provided with a support arm, the tail end of the support arm is connected with a rotating arm in a damping rotation mode, the support arm is provided with an adjusting assembly for adjusting the tightness degree of the support arm and the rotating arm, and the tail end of the rotating arm is also provided with a clamping assembly; the welding wire feeding device is simple in integral structure and convenient to fix, the flexibility of position and posture adjustment of the welding wire can be greatly improved by matching the wire feeding pipe with the fixed seat and the rotating arm, and meanwhile, the stability and the personnel safety of the welding wire are also sufficiently guaranteed.

CN Patent No. 216,177,587 for Handheld laser welding gun with parameter adjusting module by inventors Yuan Zhoghui, et al., filed Oct. 19, 2021 and issued Apr. 5, 2022, is directed to a handheld laser welding gun with a parameter adjusting module, which comprises a welding gun and a parameter adjusting module arranged on a handheld part of the welding gun, wherein the parameter adjusting module comprises a panel and a face mask covering the panel, a circuit board is arranged in the face mask, an adjusting knob, a data interface and a toggle switch are integrated on the circuit board, an adjusting hole, a plug-in port and a toggle window are arranged on the face mask corresponding to the adjusting knob, the data interface and the toggle switch, and when the handheld laser welding gun works, a data line and the data interface are connected in place, so that a worker can conveniently adjust the welding gun through the adjusting knob and the toggle switch, the product quality is ensured, the personnel allocation is reduced, and the working intensity is reduced.

CN Patent No. 216,065,895 for Hand-held type laser welding rifle with send a anchor clamps by inventors Yuan Zhoghui, et al., filed Oct. 22, 2021 and issued Mar. 18, 2022, is directed to a hand-held laser welding gun with a wire feeding clamp, which comprises a welding gun, a wire tube seat and a wire feeding tube, wherein the welding gun is arranged on the welding gun; the welding gun comprises a handheld part and a gun head part, a wire tube seat is positioned below the gun head part and is in damping rotation connection with the gun head part, a fixing hole for a wire feeding tube to pass through is arranged on the wire tube seat in a penetrating mode, one end of the wire feeding tube is inserted into the fixing hole, the wire feeding tube, the fixing hole and the welding gun are coplanar, and a locking assembly is arranged on the wire tube seat and comprises a fixing tube sleeved on the wire feeding tube and a locking head coaxially screwed with the fixing tube; a plurality of locking elastic sheets are coaxially distributed on one end of the fixed pipe, which is far away from the fiber pipe seat, and a tightening inclined surface for inwards tightening the locking elastic sheets is arranged on the inner wall of the locking head; this real welding rifle convenient to use, welding stability is strong, and during the welding, can improve the flexibility of the position gesture regulation of welding wire greatly through sending the cooperation of silk pipe and fixing base, the stability and the personnel security of welding wire have also obtained sufficient guarantee simultaneously.

CN Patent No. 214,417,931 for Industrial laser welding head by inventors Yuan Zhoghui, et al., filed Jan. 6, 2021 and issued Oct. 19, 2021, is directed to an industrial laser welding head, which comprises a mounting seat; an incident light channel, an emergent light channel and a reflected light channel are arranged in the mounting seat; the reflected light channel comprises a first channel and a second channel; a first reflector and a first motor for driving the first reflector to longitudinally rotate are arranged at the intersection of the first channel and the incident light channel; a second reflector and a second motor for driving the second reflector to horizontally rotate are arranged at the intersection of the first channel and the second channel; a spectroscope for reflecting the light beam out of the emergent light channel is arranged at the intersection of the emergent light channel and the second channel; an image acquisition unit for acquiring images of the emergent light spots is arranged on one side of the mounting seat, which is far away from the reflecting surface of the spectroscope; the mounting seat is provided with a controller unit for controlling the first motor and the second motor, an adjusting unit for adjusting the processing parameters and a display unit for displaying the processing parameters, so that the real-time monitoring and adjustment of the processing parameters are realized.

CN Patent No. 216,607,627 for Electric shock prevention and high-frequency high-voltage arc discharge prevention structure of handheld laser welding gun by inventors Yuan Zhoghui, et al., filed Nov. 26, 2021 and issued May 27, 2022, is directed to a hand-held laser welding gun electric shock prevention and high-frequency and high-voltage arc discharge prevention structure, which comprises a welding gun body, wherein the welding gun body comprises a hand-held part and a gun head part, the lower end of the gun head part is provided with a wire feeding mechanism, a first wire feeding hole is arranged in the hand-held part, one end, close to the gun head part, of the first wire feeding hole penetrates through the side wall of the hand-held part, the lower end of the gun head part is provided with a second wire feeding hole corresponding to the first wire feeding hole, the gun head part is provided with a conduction piece for conducting the first wire feeding hole and the second wire feeding hole, the outlet end of the second wire feeding hole is adjacent to the wire feeding mechanism, the conduction piece is provided with a transition groove for communicating the first wire feeding hole and the second wire feeding hole, and the conduction piece is detachably connected with the gun head part; the grounding wire protection device is simple in integral structure and convenient to use, and by arranging the first wiring hole, the second wiring hole and the conducting piece, the grounding wire is convenient to arrange under the condition that a lens group in the welding gun is not influenced, the grounding wire can be protected, and the grounding wire is prevented from being wound and exposed outside the welding gun.

CN Patent No. 216,066,008 for Antistatic handheld laser welding gun by inventors Yuan Zhoghui, et al., filed Oct. 29, 2021 and issued Mar. 18, 2022, is directed to an antistatic handheld laser welding gun, which comprises a handheld part, a gun head part and a mounting seat, wherein the handheld part and the gun head part are arranged in a split manner; a blocking plate for isolating static electricity is arranged between the gun head and the mounting seat, a through hole for laser to pass through is arranged in the blocking plate in a penetrating mode, a sealing ring which is coaxial with the through hole is arranged on one side, facing the mounting seat, of the blocking plate, a first mounting groove matched with the sealing ring is arranged on the blocking plate in a surrounding mode around the through hole, a second mounting groove matched with the sealing ring is arranged on the mounting seat, the first mounting groove and the second mounting groove jointly form a fixing cavity for fixing the sealing ring, and the gun head and the mounting seat are both detachably connected with the blocking plate; according to the utility model, the separation plate is additionally arranged between the gun head part and the mounting seat, so that the influence of static electricity on the gun head part on other components on the welding gun is avoided.

CN Patent Publication No. 114,101,899 for Multifunctional welding gun with variable welding surface light spot and light spot regulation and control method thereof by inventors Yuan Zhoghui, et al., filed Dec. 31, 2021 and published Mar. 1, 2022, is directed to a welding surface light spot variable multifunctional welding gun and a light spot regulating method thereof, wherein the welding gun comprises a welding gun body, the welding gun body comprises a gun head part, a handheld part and a connecting part; the welding gun comprises a welding gun body, a connecting part, a cooling channel, a display screen, a parameter adjusting device, a gun head part, a gas blowing hole, a gas blowing protective mirror and a protective mirror drawer, wherein the welding gun body is internally provided with a light path channel, the connecting part is internally provided with an XY axis deflection mechanism for adjusting the emergent deflection angle of an incident light beam, the connecting part is provided with the cooling channel and the display screen convenient for observing welding parameters, the handheld part is provided with the parameter adjusting device for adjusting the welding parameters, the gun head part comprises a gun head body and a base, an electrostatic shielding layer is arranged between the gun head body and the base, the base is provided with the gas blowing hole, the base is also provided with the gas blowing protective mirror and the protective mirror drawer for preventing gas flow from flowing backwards, and the handheld part is also internally provided with a wire arranging channel; the invention has compact integral structure, convenient and simple use, can realize the arbitrary switching of the point line surface processing modes, can cool the welding gun body, prolongs the service life and simultaneously can avoid the influence of static electricity on internal devices.

CN Patent No. 214,109,206 for Parameter visualization handheld laser welding gun by inventors Yuan Zhoghui, et al., filed Dec. 24, 2020 and issued Sep. 3, 2021, is directed to a hand-held laser welding gun with visual parameters, which comprises a gun head part, a hand-held part and a display component; set up the incident light passageway that supplies laser to pass through in the handheld portion, set up in the rifle head with incident light passageway complex emergent light passageway, the one end that deviates from its laser outgoing on the rifle head is equipped with the installation position of installation display module, set up the trough in the handheld portion, the trough communicates with the installation position, through encapsulating display module in the protection casing, fixes the protection casing on the rifle head again, when operating personnel welded, can master the degree of closing of welding parameter and actual welding condition in real time.

CN Patent No. 215,238,555 for Industrial laser welding head by inventors Yuan Zhoghui, et al., filed Dec. 23, 2020 and issued Dec. 21, 2021, is directed to an industrial laser welding head, which comprises a laser incidence lens group, a laser emergent lens group, a laser reflector group matching the laser incidence lens group and the laser emergent lens group, and a mounting seat for mounting the laser incidence lens group, the laser emergent lens group and the laser reflector group; an incident light channel, a reflected light channel and an emergent light channel are respectively arranged in the mounting seat corresponding to the laser incident lens group, the laser reflector group and the laser emergent lens group; be equipped with the cooling channel who supplies the cooling medium circulation in the wall body of mount pad, be equipped with the circulation interface that communicates cooling channel and supply the cooling medium circulation on the lateral wall of mount pad, be equipped with the image acquisition unit that carries out image acquisition to the emergent facula on the mount pad, the image acquisition unit is coaxial with the emergent light path of emergent mirror group, still is equipped with the display that shows processing parameter on the mount pad, and then realizes processing parameter real-time supervision, has also avoided the soldered connection high temperature.

CN Patent No. 210,677,356 for Adjustable multi-functional hand-held type laser welding rifle by inventors yuan Zhoghui, filed Oct. 16, 2019 and issued Jun. 5, 2020, is directed to an adjustable multifunctional handheld laser welding gun, which comprises a frame, a gun head and a gun handle which are connected with the frame, two adjustable reflection lenses and two fixed reflection lenses which are arranged in the frame, and two driving motors which respectively drive the two adjustable reflection lenses; the laser gun comprises a frame, wherein channels which are communicated with each other and are used for laser to pass through are arranged in a gun head and a gun handle, driving motors are arranged on the frame, the ends of rotating shafts of the driving motors extend into the channels in the frame, the different surfaces of the rotating shafts of the two driving motors are vertical, and adjustable reflection lenses are arranged on the rotating shafts; the two fixed reflection lenses are respectively arranged at two ends of a channel in the frame; two adjustable reflection lens, two fixed reflection lens form the light path structure that supplies the laser reflection to pass through, the utility model has the advantages of simple overall structure, can realize the arbitrary switching of some line face processing modes under the condition that need not trade the welding rifle of different grade type.

CN Patent No. 218,694,699 for Adjustable multichannel wire feeding mechanism of laser welding gun by inventor Yuan Zhoghui, filed Nov. 1, 2022 and issued Mar. 24, 2023, is directed to a novel multi-channel wire feeding mechanism of a laser welding gun, which comprises a fixed seat, a movable head which is detachably arranged on the fixed seat, and a connecting frame which is arranged on the fixed seat; the movable head is equipped with out the silk passageway, goes out the silk passageway and is equipped with two entrys at least and all communicates with the export of the other end, and the passageway between export and each entry is and is sharply to appear, corresponds two coaxial seal wire passageways that are equipped with of entry on the fixing base, during the use, can send two welding wires out the export simultaneously through two entries that go out the silk passageway, and the structure practicality of the single welding wire of comparing is stronger in addition, and production and processing is more convenient.

CN Patent No. 219,093,982 for Laser welding anti-splashing structure and laser welding head with same by inventor Yuan Zhoghui, filed Jan. 18, 2023 and issued May 30, 2023, is directed to a laser welding anti-splashing structure and a laser welding head with the same, wherein the structure comprises a base arranged corresponding to a light outlet of the laser welding head and an anti-spraying plate arranged on one side of the base away from the welding head; the base and the blowout prevention plate are respectively provided with a through hole corresponding to the light outlet of the laser welding head, a cavity between the two through holes forms a blowout prevention cavity, the base is provided with a mounting plate, the blowout prevention plate is connected with the base through the mounting plate, the inside of the mounting plate is provided with an air chamber cavity, the inner wall of the air chamber cavity is provided with an air inlet, and the inner wall of the air chamber cavity facing the blowout prevention cavity is provided with a strip-shaped air outlet which forms an air wall completely transversely crossing the blowout prevention cavity; during operation, prevent that the board stops most splashes, further through the air inlet admitting air, the air chamber is with the air balance and blow out through strip air outlet for the air wall crosscut that the formation of blowing prevents spouting the chamber, and then prevents to pass in the through-hole of through-hole on the board entering base of preventing splashing, and then prevents that splashing from polluting the lens on the welding head.

### SUMMARY OF THE INVENTION

The present invention relates to a versatile laser cleaning system and method of removing superficial materials from a substrate using an adjustable laser beam.

It is an object of this invention to provide a versatile laser cleaning system that removes superficial materials from a substrate through use of a configurable laser beam while avoiding damage to the underlying substrate.

In one embodiment, the present invention includes a method of laser ablation-based cleaning, including tuning a frequency and/or power of a laser wand based a material for a corrosion-laden substrate to be cleaned, selecting a pattern to be emitted from the laser wand, wherein the pattern is not linear, aiming the laser wand at the substrate, and activating the laser wand to emit a laser at the substrate, thereby cleaning the substrate.

In another embodiment, the present invention includes a method of laser ablation-based cleaning, including tuning a frequency and/or power of a laser wand based a material for a corrosion-laden substrate to be cleaned, selecting a pattern to be emitted from the laser wand, aiming the laser wand at the substrate, and activating the laser wand to emit a laser at the substrate, thereby cleaning the substrate, wherein the laser wand emits a pulsed wave laser at a power of approximately 2000 W.

In yet another embodiment, the present invention includes a laser ablation apparatus including a laser ablation housing including an air compressor, a laser wand, a cooling system, wherein the laser ablation housing houses the cooling system, wherein the cooling system is operable to cool the laser wand, wherein the laser wand is operable to emit a laser beam in various patterns, and wherein the laser ablation system is operable to ablate a substance off a substrate without damaging the substrate.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a perspective view of a laser ablation wand according to one embodiment of the present invention.

FIG. 2A illustrates a side view of a laser ablation wand according to one embodiment of the present invention.

FIG. 2B illustrates a rear view of a laser ablation wand according to one embodiment of the present invention.

FIG. 2C illustrates a side view of a laser ablation wand according to one embodiment of the present invention.

FIG. 2D illustrates a front view of a laser ablation wand according to one embodiment of the present invention.

FIG. 3 illustrates a side view of a laser ablation wand with connecting wires and tubes according to one embodiment of the present invention.

FIG. 4 illustrates a rear view of a laser ablation wand with a display screen according to one embodiment of the present invention.

FIG. 5 illustrates a perspective view of a laser ablation system with laser wand holster according to one embodiment of the present invention.

FIG. 6 illustrates a front perspective view of a laser ablation system according to one embodiment of the present invention.

FIG. 7 illustrates a rear perspective view of a laser ablation system with cooling fan according to one embodiment of the present invention.

FIG. 8 illustrates a heat sink in a housing according to one embodiment of the present invention.

FIG. 9 illustrates a perspective view of a heat sink according to one embodiment of the present invention.

FIG. 10 illustrates a perspective view of the components contained in the laser ablation system housing according to one embodiment of the present invention.

FIG. 11 illustrates a perspective view of the components contained in the laser ablation system housing according to one embodiment of the present invention.

FIG. 12 illustrates a front view of a laser ablation system according to one embodiment of the present invention.

FIG. 13 illustrates an air compressor tray for a laser ablation system housing according to one embodiment of the present invention.

FIG. 14 illustrates a graphical user interface for a control board for a laser ablation system according to one embodiment of the present invention.

FIG. 15 is a schematic diagram of a system of the present invention.

### DETAILED DESCRIPTION

The present invention is generally directed to a versatile laser cleaning system and method of ablating substances off a substrate.

In one embodiment, the present invention includes a method of laser ablation-based cleaning, including tuning a frequency and/or power of a laser wand based a material for a corrosion-laden substrate to be cleaned, selecting a pattern to be emitted from the laser wand, wherein the pattern is not linear, aiming the laser wand at the substrate, and activating the laser wand to emit a laser at the substrate, thereby cleaning the substrate.

In another embodiment, the present invention includes a method of laser ablation-based cleaning, including tuning a frequency and/or power of a laser wand based a material for a corrosion-laden substrate to be cleaned, selecting a pattern to be emitted from the laser wand, aiming the laser wand at the substrate, and activating the laser wand to emit a laser at the substrate, thereby cleaning the substrate, wherein the laser wand emits a pulsed wave laser at a power of approximately 2000 W.

In yet another embodiment, the present invention includes a laser ablation apparatus including a laser ablation housing including an air compressor, a laser wand, a cooling system, wherein the laser ablation housing houses the cooling system, wherein the cooling system is operable to cool the laser wand, wherein the laser wand is operable to emit a laser beam in various patterns, and wherein the laser ablation system is operable to ablate a substance off a substrate without damaging the substrate.

None of the prior art discloses a highly flexible laser ablation system that utilizes a plurality of configurable laser beam formations and provides the means to alter beam parameters quickly and easily in order to meet the varying requirements caused by different substrates.

Laser ablation (sometimes referred to as “photoablation”) is a process of removing or cleaning substance off an underlying material (referred to as “substrate” throughout this disclosure) by irradiating it with a laser beam. Laser ablation works by targeting focused laser energy in a specific intensity, manner, and formulation and at frequency such that the substance sought to be removed absorbs the laser's energy and is thus ablated while the substrate remains unharmed. For cleaning and removal purposes, a straight, modified, or pulsed laser beam may be used which directs highly concentrated energy at the material positioned atop the substrate in frequent, short, modified, rotating, or otherwise patterned bursts (e.g., over a thousand times a second). This ablates the superficial material while also preventing the substrate from absorbing the laser's energy, which would result in damage to the substrate. While there are several alternative methods of cleaning surfaces in ways other than the present laser ablation invention, such as sanding, chemical treatment, sandblasting, dry ice blasting, and raw or un-reconfigured laser ablation, these cleaning methods are much more damaging, ineffective, and time consuming than the present laser ablation invention, and many have a much more harmful environmental impact. Additionally, there are a number of benefits provided by laser ablation over conventional cleaning methods. The present laser ablation invention is up to twenty or more times faster than conventional methods of cleaning and rust removal, e.g., sand-blasting, chemicals, sanding, or dry-ice blasting; it requires minimal set-up compared to conventional methods; it produces significantly less waste than conventional methods; if applied properly, it provides minimal to zero damage to the underlying substrate; and the persons, mechanism, and/or equipment used, and the surrounding environment, suffer from comparatively minimal adverse effects, making it especially suited for removing rust and other superficial layers of unwanted materials from a very large variety of substrates and materials, large and small, simple and complex, e.g., massive steel structures, old furniture, large and small wooden objects, aged paintings, antiques, jewelry, automobiles, large and/or complex machinery and equipment; among a plethora of other benefits.

However, applying a properly configured laser beam to the surface of a substrate to remove a coating or some other material without damaging the substrate or otherwise causing collateral damage or problems (e.g., by creating and needing to remove detritus from, or waste products necessitated by, the operation itself), is easier said than done. This issue is compounded when dealing with highly delicate substrates that must not be altered in order to be aesthetically appreciated (e.g., jewelry or art), or to function (e.g., highly precise machinery), or very large equipment to which a properly configured laser beam must be appropriately applied.

At lower or unmodified laser flux or intensity, the superficial material on the substrate, and the substrate may itself be heated by the absorbed laser energy and thus is sometimes itself damaged, even though undesirable superficial material is ablated. Often, a properly configured laser ablation technique utilizes a modified or pulsed laser beam, rather than a continuous wave beam, with an extremely short transmission period (i.e., measured in femtoseconds). A pulsed laser beam is often used because it is less likely to damage the underlying substrate since the substrate does not have enough time to absorb the laser energy and heat build-up that may otherwise cause striping, marking, warping or other similar damage to the substrate itself. However, utilizing a properly configured and proper intensity wave beam produces no such damage. In addition, a stronger, more focused, or otherwise unmodified beam may be necessary to remove certain substances. Furthermore, regardless of the type of laser beam used (i.e., pulsed or continuous) the underlying substrate is at risk of damage due to improper use by a technician (e.g., improper frequency, power setting, pattern, etc. Another downfall of the prior art is the lack of adjustability in the parameters of the laser beam emitted by the laser ablation system. Utilizing a laser beam for cleaning purposes (i.e., laser ablation), requires a highly adjustable laser beam. Therefore, a system that enables a user to adjust these parameters in a single laser ablating system is highly advantageous over the prior art.

Therefore, there is a need for a highly adjustable laser ablation system, operable to enable a wide range of laser parameters in a single laser ablation system that further balances the need for a gentle laser beam that does not damage the underlying substrate but still efficiently and effectively cleans the targeted surface.

The present laser ablation invention exploits the fact that different substrates have varying levels of hardness, rigidity, and complexity, and that the superficial layers needing ablation may have varying properties (e.g., dust-covered or repainted oil paintings, modified jewelry, wooden or metal structures with various types of surface modifications, such as newer paint, modifications of the underlying image, varnish, oil, other coatings, dust, detritus, etc.), and thus present specific frequencies at which they may absorb light energy. The present invention seeks to utilize a laser beam of proper configuration, intensity, and frequency that is absorbed and thus ablated as to the material or substance to be removed but is not absorbed or adversely affected by the underlying substrate. Avoiding a laser ablation process that damages a large and complex variety of underlying substrates is paramount to the use of laser ablation.

As used herein, “substrate” refers to the surface of an object, device, substance, or material upon which one or more additional layers of superficial undesirable substances or materials have formed, been applied, or developed over time (e.g., rust, dirt, debris, sludge, crystals, dust, paint, coating, powder coating, ink, varnish, oil, etc.). For further clarity, as used throughout the present disclosure, substrate refers to the underlying material sought to be cleaned and the “substance” or “superficial material” refers to the material atop the substrate sought to be removed.

Referring now to the drawings in general, the illustrations are for the purpose of describing one or more preferred embodiments of the invention and are not intended to limit the invention thereto.

### Laser Ablation System

In one embodiment, the laser ablation system includes a laser wand, a control box, a power supply, a plurality of connecting wires, a plurality of connecting tubes, a cooling system, a laser medium, a circuit board, a lens protecting air blower, and/or a housing.

In one embodiment, the laser ablation system is operable to enable a user of the system to change the parameters of the laser beam. In one embodiment, the parameters operable to be adjusted include, but are not limited to, laser frequency, wavelength, pattern, laser dot radius, intensity, gain bandwidth, monochromacity, directionality, spatial and temporal profiles, collimation, output power, coherence, polarization as well as, the wattage supplied to the system and/or the laser beam. In one embodiment, the laser beam's current and Local Oscillator (OL) voltage is modulated at a frequency of 500 Hz to 30 kHz, and the photodetector voltage is demodulated at the appropriate frequency.

In one embodiment, the plurality of connecting wires includes a control line, operable to electronically communicate parameter information from the system to the laser wand.

In one embodiment, the laser ablation system includes a touch-pad control panel, operable to display parameter information, as well as display a Graphical User Interface (GUI) enables a user to alter and/or adjust the parameters of the laser ablation system.

In one embodiment, the plurality of connecting tubes includes a fiber optic cable, a light line, and/or a plurality of cooling lines.

In one embodiment, the laser ablation system is operable to emit a pulsed laser beam (i.e., not a continuous wave). In one embodiment, the laser ablation system is operable to emit a continuous wave laser beam. In one embodiment, the laser ablation system is operable to emit a continuous wave laser beam that exhibits properties of a pulsed laser beam. The present invention solves a longstanding unmet need by providing a continuous wave laser beam operable to clean or ablate an undesired layer or substance from a substrate without damaging the underlying substrate.

In one embodiment, the laser ablation system is operable to alter the parameters of the emitted laser beam. These parameters include, laser frequency, wavelength, pulse length, gain bandwidth, monochromaticity, spatial and temporal profiles, collimation, coherence, polarization, and/or wattage.

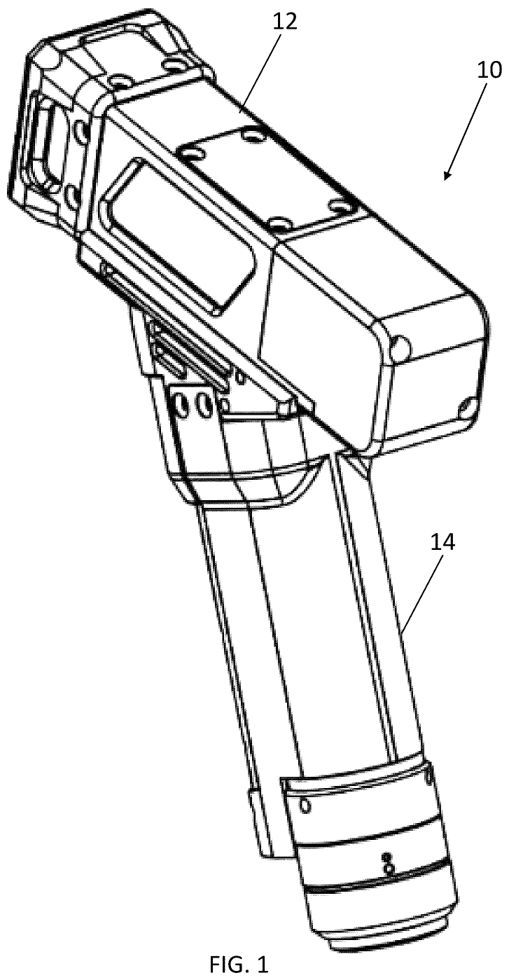

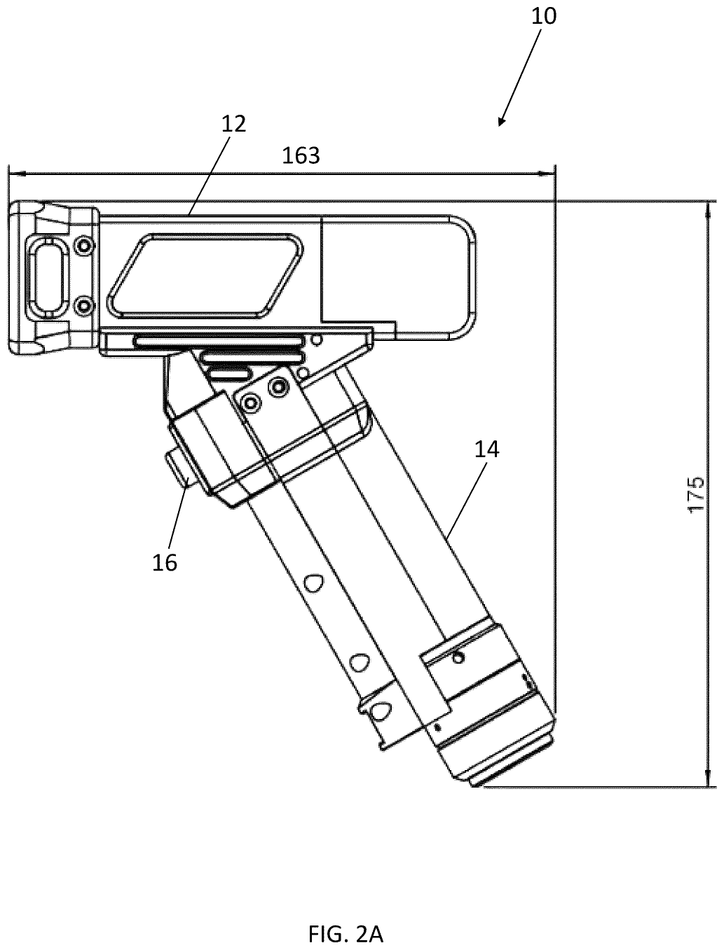

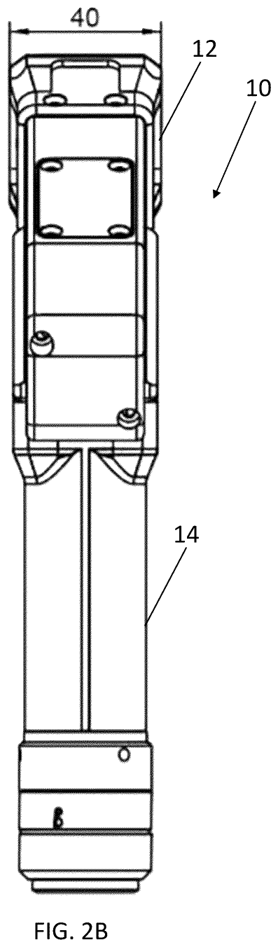

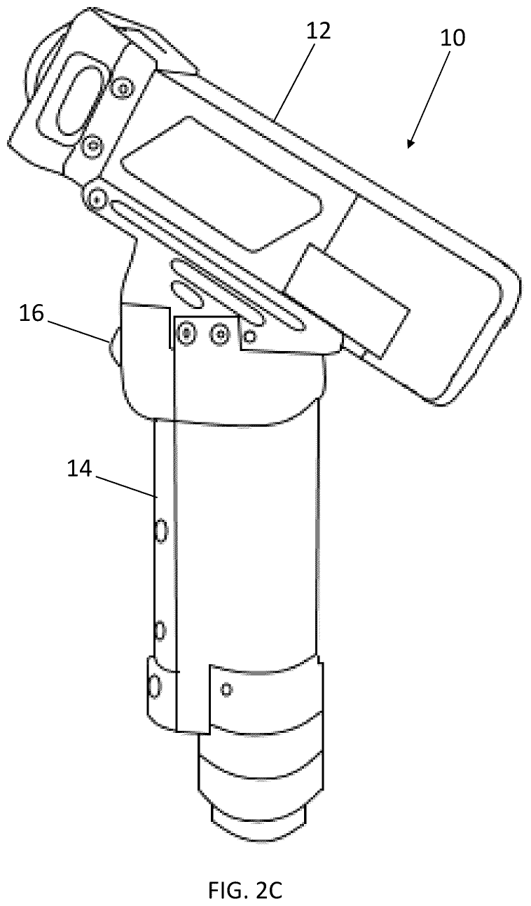

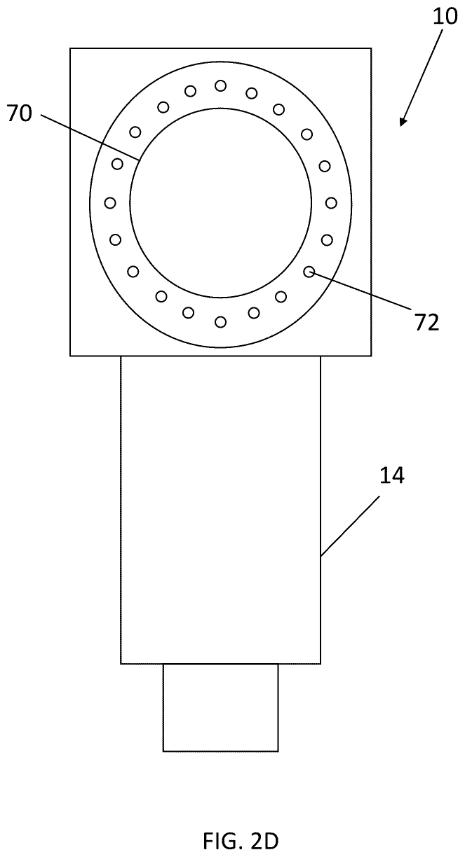

FIG. 1 and FIGS. 2A-2C illustrate a laser ablation wand according to one embodiment of the present invention. In one embodiment, the laser wand 10 includes a protective lens, a cooling lens, a wand head body 12, a handle 14, a power switch button 16, a plurality of light reflecting lenses, and/or a collimator.

FIG. 2D illustrates a front view of a laser ablation wand according to one embodiment of the present invention. As shown in FIG. 2D, the front of the laser wand 10 includes a protective lens 70 from which a laser is emitted. It is important to ensure that the lens 70 is clean and not obstructed with dust to ensure that the laser that is emitted is sufficiently strong to perform cleaning as expected. In one embodiment, a plurality of air holes 72 surround the protective lens 70 and are configured to deliver air from an air compressor within a chassis to blow across the lens 70 to remove any dust or other debris. In one embodiment, the air holes 72 are positioned at an angle (e.g., not emitting air directly orthogonally to the protective lens surface) such that the air is more easily able to clean the lens 70.

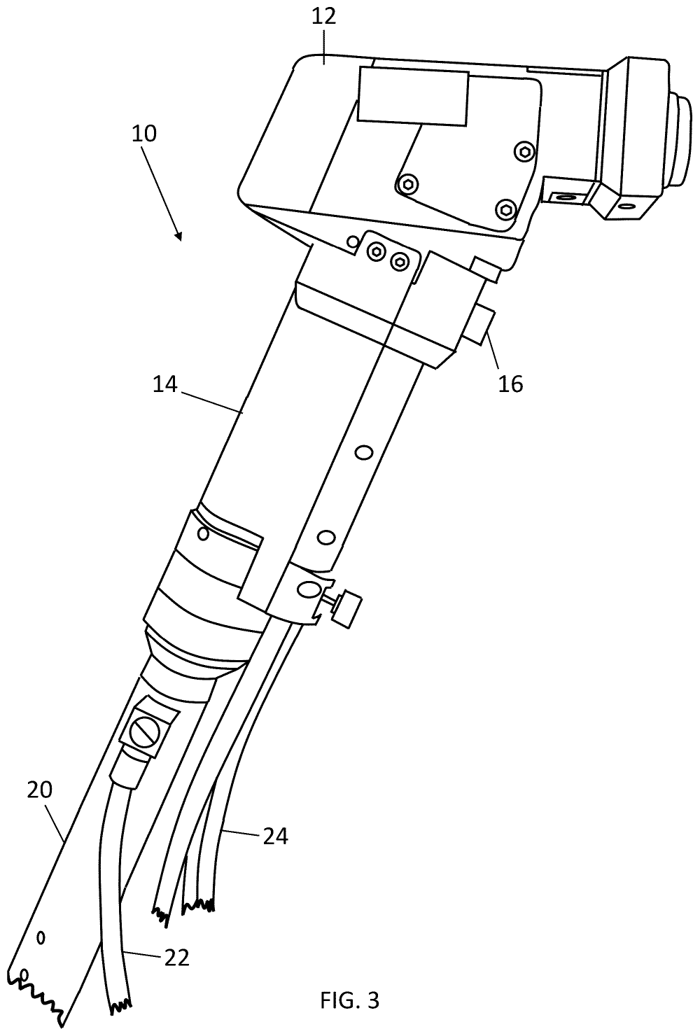

FIG. 3 illustrates a side perspective view of a laser ablation wand with connecting wires and tubes according to one embodiment of the present invention. In one embodiment, the connecting wires and tubes includes the control line 20, plurality of cooling tubes 22, and/or fiber optic cable 23. In one embodiment, the plurality of connecting wires and tubes includes an air line, operable to blow air out of the laser wand 10 in order to protect the protective lens from dust and other small particles.

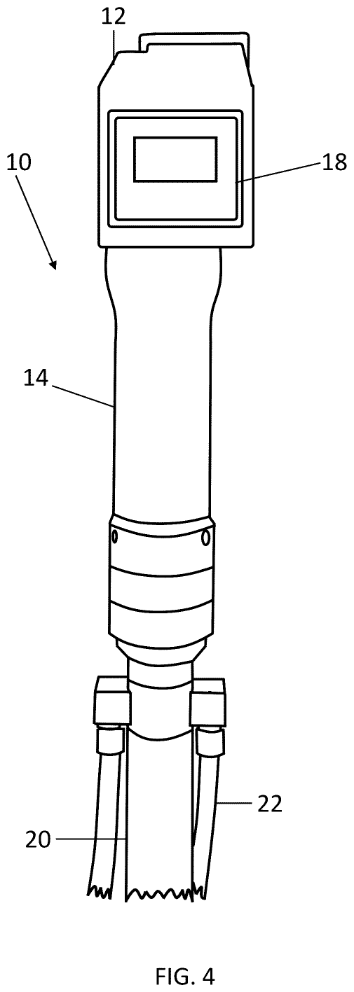

FIG. 4 illustrates a rear perspective view of a laser ablation wand with a display screen according to one embodiment of the present invention. In one embodiment, the laser ablation wand 10 includes a display screen 18, operable to display parameter information to a user of the system.

In one embodiment, the laser wand 10 is operable to emit a laser beam in a plurality of rotating patterns. In one embodiment, the laser wand 10 is operable to store the parameters of the plurality of rotating patterns. In one embodiment, the laser ablation system is equipped with a circuit board, control board, and/or memory unit operable to store the parameters information of the laser ablation system (i.e., plurality of rotating patterns, laser frequency, wattage, etc.).

In one embodiment, the laser ablation system is operable to utilize a double wobble wand head. The double wobble wand head is operable to provide a plurality of motions during laser ablation, such that the laser beam moves in specific predetermined patterns as it ablates. For clarity, “wobble” refers to a consistent dynamic motion. In one embodiment, the double wobble wand head is operable to emit a laser beam in a circular wobble motion, a linear wobble motion, a double oval wobble motion, a figure eight wobble motion, a Celtic cross, a snowflake, a flower, a square, a circle, and/or an infinity symbol wobble motion. In one embodiment, the double wobble wand head of the laser ablation system is operable is split the laser beam, such that the energy of the beam is fractionalized. In one embodiment, the system does not use a linear laser pattern for ablation. Linear laser patterns are common in the prior art, but often damage the substrate that is being cleaned.

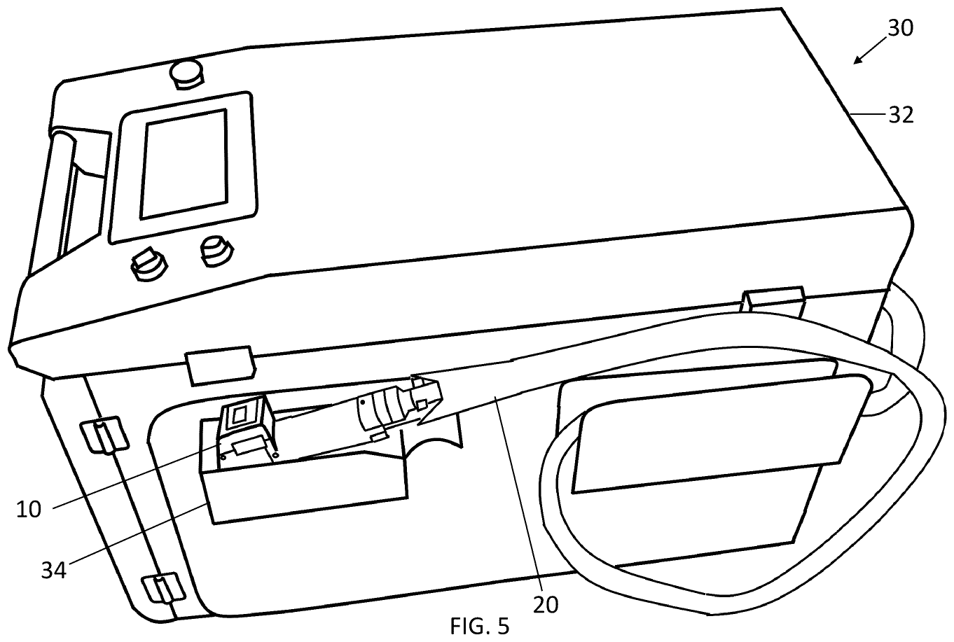

FIG. 5 illustrates a perspective view of a laser ablation system with laser wand holster according to one embodiment of the present invention. In one embodiment, the laser ablation system 30 includes a housing 32, to house the internal components of the system, and a laser wand holster 34, operable to hold the laser wand 10 while not in use.

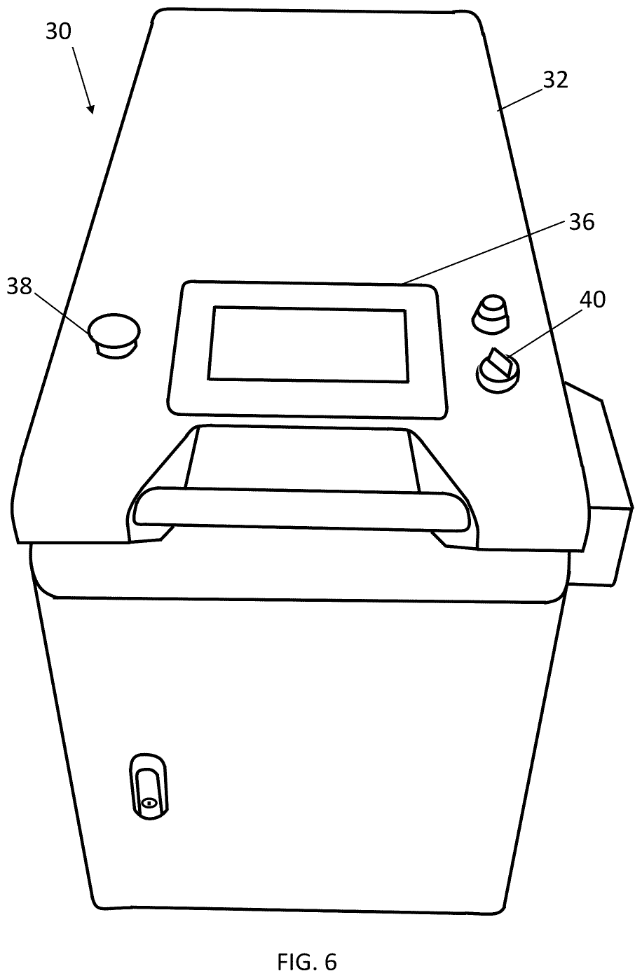

FIG. 6 illustrates a front perspective view of a laser ablation system according to one embodiment of the present invention. In one embodiment, the laser ablation housing 30 includes a control panel touch-pad 36, a plurality of switches 40, and/or a cut-off button 38. In one embodiment, the control panel touch-pad 36 is operable to display a variety of information pertaining to the parameters of the laser ablation system 30 (e.g., wattage, frequency, wavelength, pattern, temperature, laser beam dot size etc.). The control panel touch-pad 36 is further operable to provide the means to alter the parameters of the laser ablation system 30 by functionally communicating with a circuit board of the system. In one embodiment, the control panel touch-pad 36 is operable to change the wattage, frequency, wavelength, and/or pattern of the laser beam through a Graphical User Interface (GUI), which presents current readings of such parameters with interactive buttons to alter them.

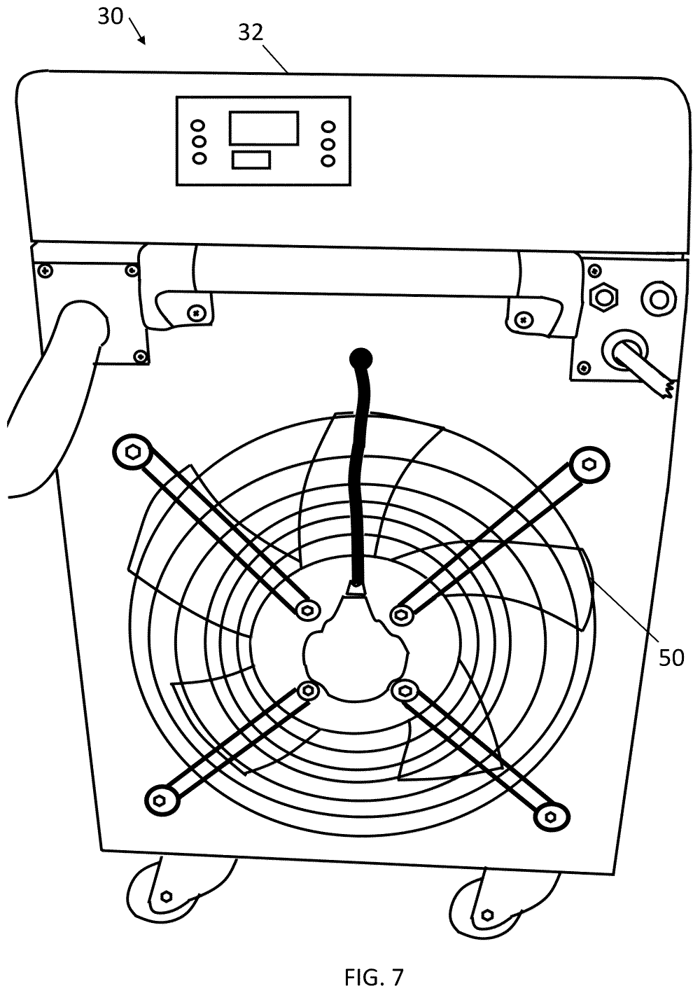

FIG. 7 illustrates a rear perspective view of a laser ablation system with cooling fan according to one embodiment of the present invention. In one embodiment, the laser ablation housing 30 includes an intake fan 50, operable to move air from inside the housing 32 to outside the housing 32. Alternatively, the fan 50 is operable to move air from outside the housing 32 to inside the housing 32 to cool the components included in the housing 32. In one embodiment, the laser ablation system 30 of FIG. 7 includes a temperature monitor for a coolant chiller and an air intake valve.

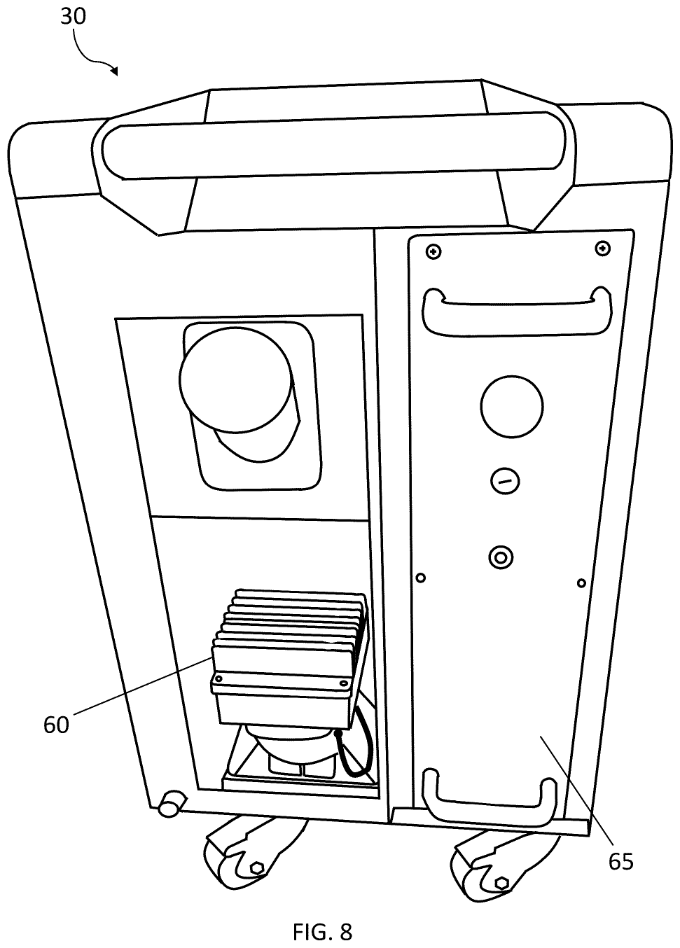

FIG. 8 illustrates a heat sink 60 in a housing 30 according to one embodiment of the present invention. In one embodiment, the laser ablation housing 30 includes a heat sink 60 and/or radiator positioned inside the housing, operable to cool the laser ablation system and a laser system 65.

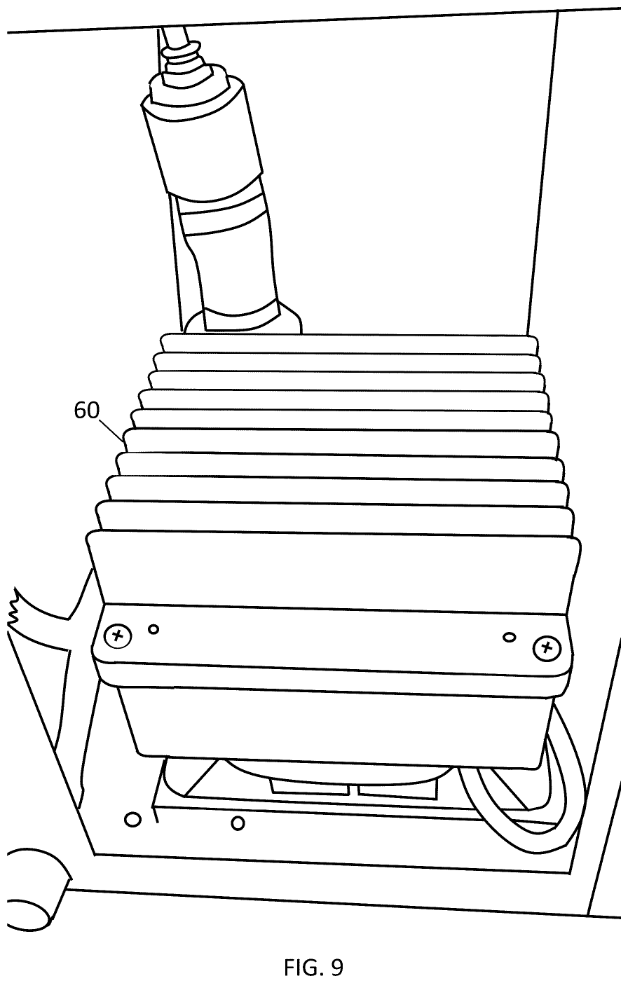

FIG. 9 illustrates a perspective view of a heat sink according to one embodiment of the present invention. In one embodiment, the cooling system includes a single and/or a plurality of heat sinks 60. In one embodiment, the cooling system includes a water-cooling system. In one embodiment, the water-cooling system includes a plurality of tubes operable to transport a liquid coolant (e.g., water, deionized water, inhibited glycol and water solution, dielectric fluids, and/or any other suitable liquid coolant), at least one radiator 60 operable as a heat sink, at least one fan, at least one water pump, and/or a coolant reservoir. In one embodiment, the cooling system includes both water cooling capabilities and air-cooling capabilities.

In one embodiment, the cooling system includes a plurality of liquid coolant and/or air transport tubes operable to move liquid coolant and/or air throughout the cooling system. In this embodiment, the plurality of transport tubes creates a network of tubes from the cooling system and up to the laser wand, such that the wand is also cooled. In one embodiment, the plurality of transport tubes split, such that a portion of the cooling liquid and/or gas travels to the laser wand and a portion of the cooling liquid and/or gas travels to the laser medium. In one embodiment, cooling liquid and/or gas travels from the cooling system and is split, such that a portion of the cooling liquid and/or gas travels to the laser and a portion of the cooling liquid and/or gas travels to the laser wand. In one embodiment, the heat sink 60 is placed directly onto the water pump and water, through a plurality of transport tubs, transports water through the heat sink 60. Advantageously, this configuration cools the water in the water pump.

In one embodiment, the plurality of air-transport tubes are not utilized for cooling purposes. Rather, a plurality of air-transport tubes are operable to move air from an air intake valve to the laser wand in order to facilitate the protective lens protection mechanism described below.

In one embodiment, the cooling system includes an air-cooling system and does not include a water-cooling system. In this embodiment, the cooling system does not include any transport tubes for cooling purposes, rather the cooling system functions with a plurality of fans blowing air over a heat sink in order to remove heat from the heat sink.

Advantageously, by including at least one radiator 60 as a heat sink in the cooling system, the laser ablation system is designed to be much smaller and lighter than traditional laser ablation system. In one embodiment, the laser ablation system is operable to be contained within a standard size backpack or standard size suitcase when being transported. In one embodiment, inclusion of at least one radiator enables the cooling system to include a smaller coolant reservoir (due to the need for less coolant), and/or fewer fans.

The cooling system of the present invention is operable to be disconnected by hand and removed from the unit without the use of any tools and replaced such that a defective cooling system is operable to be replaced quickly.

In one embodiment, the heat sink 60 is positioned on the water pump, such that it is operable to cool the coolant (i.e., water) as it flows through the water pumped and/or heat sink 60. This cooling system is further connected to the back panel of the laser component of the laser ablation system and operable to cool the laser component. The back panel of the laser component includes a coolant in and coolant out connections in order to function with the cooling system. In one embodiment, the heat sink 60 only cools off the water that is going through the water pump and the heat sink is only connected to the water pump. In this embodiment, the cooling system connects to the laser component via the back panel through a water in and water out connection on the back panel of the laser component.

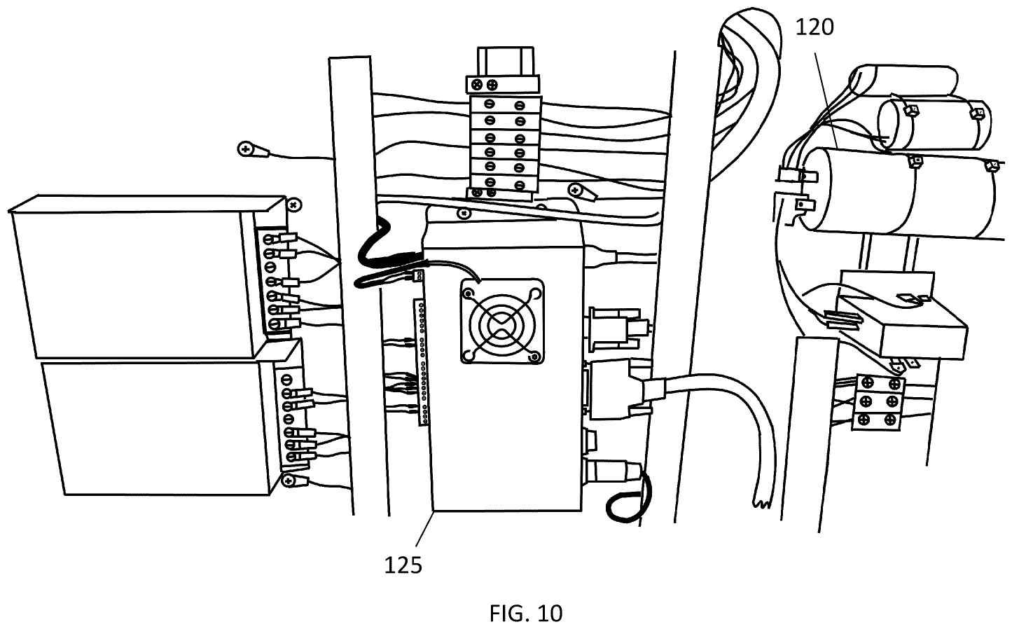

FIG. 10 illustrates a perspective view of the components contained in the laser ablation system housing according to one embodiment of the present invention. In one embodiment, the laser ablation housing houses a condenser 120, a control board 125, and/or a power distribution unit.

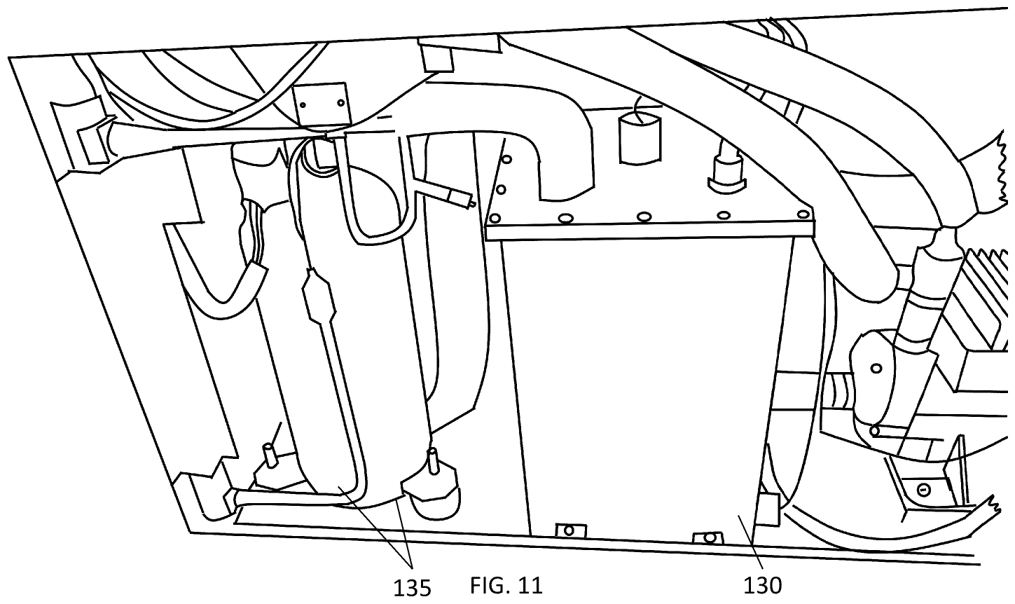

FIG. 11 illustrates a perspective view of the components contained in the laser ablation system housing according to one embodiment of the present invention. In one embodiment, the laser ablation housing houses a water reservoir 130 with a plurality of transport tubes and a plurality of condensers 135.

In one embodiment, the laser wand is operable to blow air towards the substrate while laser ablating. In one embodiment, the laser wand is operable to blow air from the protective lens in order to protect the protective lens. In one embodiment, the laser system includes an air hose from the laser ablation system housing to the laser wand. In one embodiment, the laser ablation system includes an air intake value, operable to move air from outside the system, into a plurality of transport tubes, and out of the laser wand. In one embodiment, this process is accomplished using at least one fan, operable to move the air. In this embodiment, the laser wand is equipped with an air exit hole proximate to the protective lens, such that, as air exists the laser wand, it is directed outwardly away from the protective lens. This produces an air current about the protective lens, such that dust or small particles of the ablated substance does not make contact with the protective lens. In one embodiment, the laser wand includes a crowned connector attached to the protective lens, such that the divots and/or indentation of the crowned connector create airways for the blown air to travel out of the laser wand and about the protective lens. Advantageously, by including the air blowing capabilities of the laser wand, catastrophic destruction of the protective lens is avoided. This is due to the fact that if a dust particle or small particle of the ablated substance does contact the protective lens, the laser beam will make contact with the particle, heat it up, and damage the protective lens.

In one embodiment, the laser ablation system includes a vacuum pump. In one embodiment, the vacuum pump is operable to remove the ablated material from the atmosphere of the cleaning site. In one embodiment, while the vacuum system may not be physically connected to the laser ablation system, it is utilized in the laser cleaning process to remove ablated superficial material from the work area.

Advantageously, the laser ablation system is designed in such a way to maximize compactness and movability by decreasing the size of the system. In one embodiment, compactness and movability is achieved by utilizing the cooling system described, which includes less liquid for coolant (i.e., a smaller reservoir) and/or an exclusively water-cooled cooling system. Advantageously, by utilizing the cooling system described above, the laser ablation system is manufactured in a smaller and more compact size, which improves mobility of the system.

In one embodiment, the laser ablation system is operable to emit a continuous wave laser beam that exhibits properties of a pulsed wave laser beam. The laser ablation system is operable to operate at different wattages, including but not limited to, 300 W, 500 W, 1000 W, 2000 W, or other wattages. Each of these wattages is compatible with both pulsed laser and continuous laser systems according to the present invention. In particular, in one embodiment, the present invention includes a 2000 W pulsed laser system.

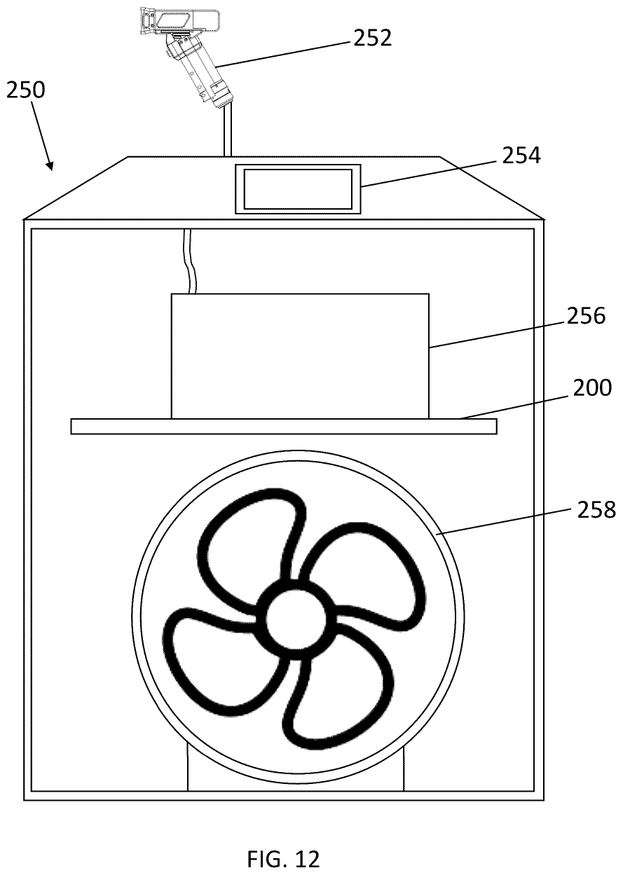

FIG. 12 illustrates a front view of a laser ablation system according to one embodiment of the present invention. In one embodiment, a laser ablation system chassis 250 according to the present invention includes an air compressor 256. The air compressor 256 is positioned on a shelf 200 above a cooling fan 258 in the chassis 250. This air compressor 256 is therefore connected to a laser wand 252 of the system and operable to pump air to clean the surface of the laser wand 252. This provides a significant advantage over any prior art systems, which require external air compressors to be connected to a port in the exterior of the chassis 250 and therefore require an often very heavy component to be carried in addition to the chassis 250. Furthermore, many external air compressors are heavier and larger than required for the particular application, meaning there is a substantial amount of deadweight. The chassis 254 includes a control panel from which the system is operable to be controlled.

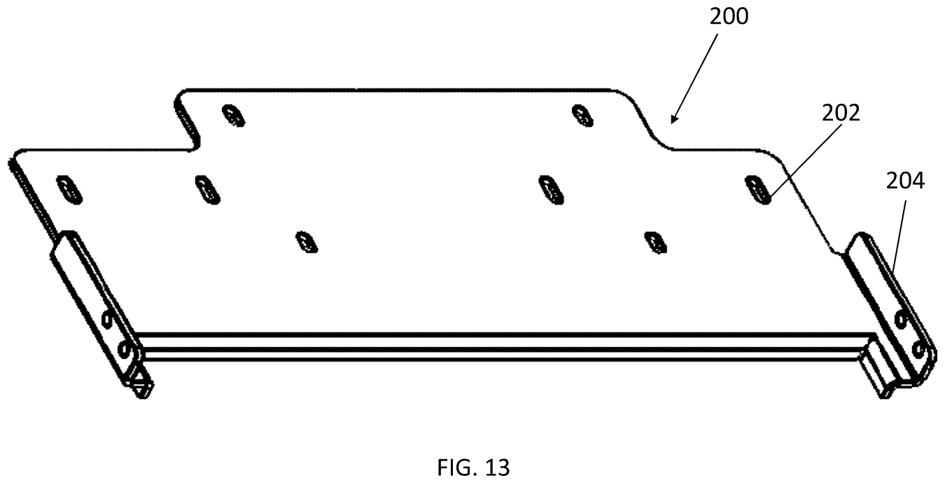

FIG. 13 illustrates an air compressor tray for a laser ablation system housing according to one embodiment of the present invention. FIG. 13 illustrates an example shelf 200 operable to be used to hold an air compressor. In one embodiment, the shelf 200 includes one or more recesses 202 operable to receive feet or other alignment components of the air compressor. This further allows the system to have the air compressor be easily removable, allowing for easy replacement or repair of the device. In one embodiment, the shelf 200 includes side tracks 204 operable to attach to an internal shelf within the chassis and/or to allow the shelf 200 to move inwardly and outwardly to and from the chassis interior.

### Predetermined Parameter Configuration

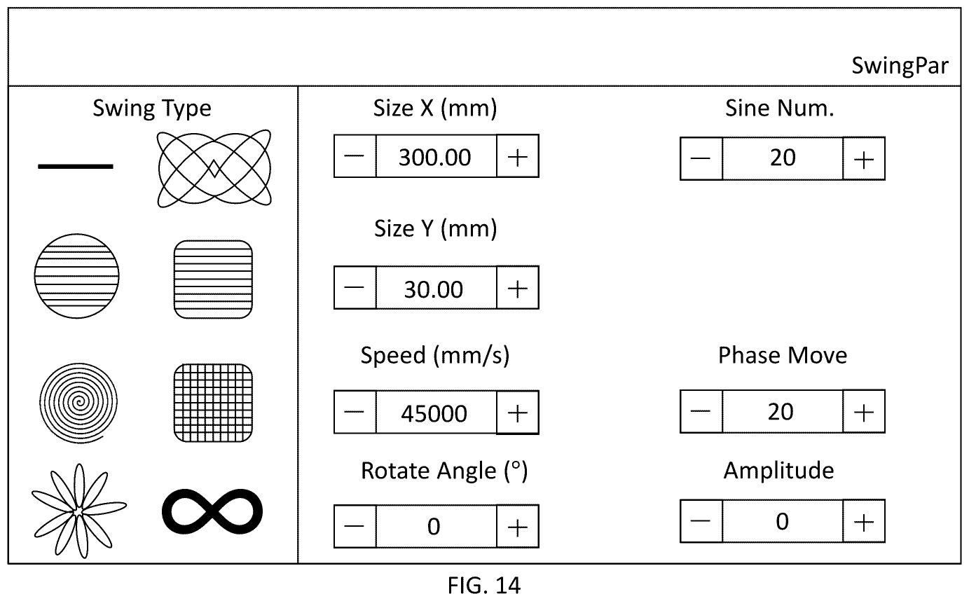

FIG. 14 illustrates a graphical user interface for a control board for a laser ablation system according to one embodiment of the present invention. The laser ablation system chassis described in the present invention is operable to include a control panel with buttons and/or a touch screen operable to receive user input to change parameters of operation of the laser ablation system. While FIG. 14 depictions an embodiment having “plus” and “minus” buttons, selection of which always for adjustment of different parameters. However, one of ordinary skill in the art will understand that other acceptable methods of receiving user input for changing parameters include, but are not limited to, sliders, dials, text keyboard input modules, and/or other graphical user interface (GUI) input methods. In the GUI shown in FIG. 14, parameters such as the size in X direction, size in the Y direction, speed of the laser, angle, sine number, phase, amplitude, and/or additional parameters are operable to be modified, and one of ordinary skill in the art will understand that this list is not intended to be exhausted and the parameters are operable to be changed based on the specific pattern selection. The “throw angle” of the laser is operable to be adjusted so that the intensity of the laser is the same or substantially the same for the laser pattern, regardless of the distance of each point of the laser pattern from the laser ablation system. This provides for use of the present invention in situations where the system is used to clean vertical surfaces.

In one embodiment, the platform is operable to receive click selection of a pattern, as shown on the right in FIG. 14.

In one embodiment, the laser ablation system includes a circuit board operable to store a plurality of configurable predetermined parameters of the laser ablation system. More specifically, the laser ablation system is operable to store different laser parameters (e.g., frequency, wattage, pattern, repetition rate, wavelength, strength, etc.), for different cleaning jobs. In one embodiment, the laser ablation system is operable to connect each predetermined parameter set with a character, phrase, and/or number, such that the character, phrase, and/or number is input into the laser ablation system to access the parameters. Advantageously, by including the parameter sets into the laser ablation system a user need only input a simple character, phrase, and/or number in order to access the proper parameters for a cleaning job, which obviates the need to manually program in specific parameters each time a user switches substrate or cleaning jobs.

In one embodiment, the circuit board includes a Global Positioning System (GPS) unit, operable to generate geolocation data based on the position of the circuit board. In one embodiment, the circuit board is operable to connect the plurality of predetermined parameters with geolocation data, such that the laser ablation system is operable to load a specific predetermined parameter set based solely on the location of the circuit board. Advantageously, by including a GPS unit with the circuit board, a user of the laser ablation system need only move the apparatus to the desired cleaning location and the system is operable to automatically load the proper predetermined parameters. In one embodiment, the laser ablation system does not include a circuit board with a GPS unit operable to create and utilize location data. Rather, the laser ablation system is operable to functionally communicate with a location sensitive circuit board with a GPS unit, a GPS unit, and/or a remote computer with geolocation capabilities in order to facilitate the above-described functionality.

One issue with prior art laser ablation systems is that electricity provided at a different frequency than the system is designed for is operable to damage the system. Different power sources used to power these systems provide electricity at different frequencies. For example, a generator does not provide electricity at the same frequency as a typical wall outlet in the US. In one embodiment, the present invention includes an electromagnetic interference (EMI) filter which is operable to allow only current with a certain frequency, or current below a certain frequency, to pass through the filter. In one embodiment, an onboard computer or processor recognizes higher frequencies coming from the power source and causes current with higher frequency to be filtered out and not reach the interior components of the unit which are susceptible to being damaged. This prevents damage to the laser ablation system caused by higher frequencies. This allows the laser ablation system of the present invention to use a variety of power sources, including portable generators in areas where power is not readily available or during a power outage.

In one embodiment, the laser ablation system includes a mechanism to enable the creation of a highly adjustable laser beam, through modifiable parameters. Advantageously, the present invention provides a highly adaptable laser ablation system in order to enable a single laser ablation system operable to emit a wide variety of laser beams with different properties. In one embodiment, the laser ablation system includes a control panel (sometimes referred to as a circuit board) operable to functionally communicate with the laser system, plurality of rotating crystals, and a plurality of magnifying and/or focusing lenses. In one embodiment, the plurality of rotating crystals and plurality of magnifying lenses are in the laser wand. In one embodiment, the laser ablation system includes a control line, operable to functionally communicate the control panel with the laser wand. The control panel is operable to store and facilitate the necessary mechanical instructions in order to change the wattage supplied to the system and/or laser beam, the frequency of the laser beam, the wavelength of the laser beam, the size of the laser beam's dot (i.e., the spread), and/or the specific rotating pattern emitted. The control panel functionally communicates with the laser system, plurality of rotating crystals, and/or magnifying lenses through the control line. The control panel touch pad is operable to provide a GUI for a user to adjust the parameters of the laser beam. The control panel touch pad is operable to functionally communicate with the control panel to adjust the parameters of the system. Advantageously, by including the ability to change the parameters of the laser ablation system, a user is operable to utilize a single laser ablation system for a wide variety of laser cleaning jobs, without sacrificing the systems efficacy. This parameter adjustability is needed as depending on the substrate, superficial material, depths of cleaning needed, and/or fragility of the substrate, the laser beam may need to emit vastly different properties.

### Laser Beam Patterns

In one embodiment, the laser ablation system is operable to emit a beam of light in a plurality of rotating patterns. Traditionally, lasers are designed by shining light into a cylindrical amplifying laser medium that includes mirrors on opposite sides. Light of a specific wavelength passes into the medium and is amplified as it is reflected inside the optical cavity, creating a power increasing feedback loop. In order to escape the medium, the concentrated light must travel through one of the mirrors, the output coupler, in the form of a narrow beam which creates a dot on a surface. This continuous dot, native to traditional lasers, is a problem for laser cleaning because the small surface area created by the dot is likely to cause damage to the substrate, due to the uneven coverage caused by such a small point. Additionally, a continuous beam of light is likely to cause additional damage to the substrate if this continuous beam is not controlled. Advantageously, the laser ablation system of the present invention utilizes a laser beam in a rotating pattern to mitigate the damage to the substrate. Additionally, by including a rotating pattern, the laser ablation system mitigates the inconsistent coverage cause by the human hand and the traditional laser beam dot when shining the laser wand onto the substrate.

In order to achieve the rotating patterns, the laser ablation system is operable to direct the laser beam dot through a plurality of light reflecting crystals and a plurality of protective lenses to emit the laser beam in a rotating pattern. In one embodiment, the plurality of light reflecting crystals and/or plurality of protective lenses are positioned inside the laser wand. The plurality of light reflecting crystals are operable to direct the laser beam in different directions to create a shape. In one embodiment, the creation of a shape is produced by directing a laser beam dot onto a substrate and moving the dot such that a complete movement creates a shape along the laser beam dot's path. In one embodiment, the plurality of rotating patterns are produced by directing the laser beam (i.e., a single dot) in the desired pattern. As a nonlimiting example of this functionality, in order to produce a straight line, the laser ablation system is operable to direct the laser beam dot in a straight, horizontal pattern, which produces the line. As another nonlimiting example, in order to produce an oval, the laser ablation system is operable to direct the laser beam dot in an oval moving pattern. In one embodiment, in order to produce the rotation of the plurality of rotating patterns, the laser ablation system is operable to emit the laser beam in a repetitive bidirectional or omnidirectional pattern. As a nonlimiting example of this functionality, the laser ablation system is operable to emit a laser beam in an oval pattern but after completing an initial oval shape, the next oval shape is positioned such that the elongated ends are facing in a different direction. This process is repeated to create the plurality of rotating patterns. One of ordinary skill in the art will appreciate how the plurality of light reflecting crystals and protective lenses are operable to produce a wide variety of rotating patterns.

In one embodiment, the laser ablation wand includes only one protective lens. In one embodiment, the plurality of protective lenses is operable to disperse the laser's beam to a wider and/or larger shape. In one embodiment, the plurality of protective lenses are magnifying glasses operable to focus or disperse the laser's beam.

Advantageously, by producing a plurality of rotating patterns, the laser ablation system is operable to disperse the laser beam's energy over a wide surface area of the substrate, rather than a specific point, which reduces damage to the underlying substrate. This is accomplished by continuously moving the laser's beam in the rotating pattern over the substrate, such that the laser's beam contacts the surface of the substrate in an even, consistent manner.

In one embodiment, the beam of light is emitted as a rotating Celtic cross pattern, double oval pattern, halo pattern, a nonrotating straight line, double helix pattern, and/or spinning X pattern. In one embodiment, the beam of light is emitted as a rotating double triangle, double X, and/or in a snowflake pattern. In one embodiment, a control board of the laser ablation system is operable to store and facilitate the instruction of the movements of the plurality of crystals and plurality of protective lenses to produce the plurality of rotating patterns.

In one embodiment, the laser ablation system is operable to emit a beam of light at a plurality of different intensity levels by applying varying wattage levels to the system. In one embodiment, the wattage of the laser beam is alterable utilizing the control panel touch pad.

In one embodiment, the laser ablation system is operable to emit a beam of light in a plurality of different sizes. For clarify, the laser ablation system, while operable to emit a laser beam in a plurality of rotating patterns, does so through movement of a single dot. The laser ablation system is operable to emit the dot of its laser beam in a plurality of different sizes. In one embodiment, the laser ablation system includes at least one magnifying lens, operable to adjust the size of the laser beam's dot. In one embodiment, the control panel is operable to functionally communicate with the at least one magnifying lens in order to narrow or widen the laser beam's dot (i.e., decrease or increase the radius of the dot). The laser ablation system is operable to compound the dot adjusting operability with the plurality of rotating patterns. In one embodiment, by producing a wider or narrower laser beam dot, the laser ablation system is operable to adjust the strength of the laser beam. For clarity, by producing a wider laser dot, the laser beam is less intense (i.e., lower laser intensity). By contrast, by producing a narrower laser dot, the laser beam is more intense (i.e., high laser intensity. In one embodiment, the laser ablation system is operable to adjust the laser beam's intensity.

### Method of Use

In one embodiment, the present invention includes a method of cleaning a superficial material off a substrate utilizing laser ablation (e.g., rust off metal).

In one embodiment, the present invention is operable to remove a superficial material off a substrate without harming, damaging, or adversely affecting the underlying substrate. In one embodiment, the substance is removed from the substrate by passing the laser beam from the laser ablation system over the substrate. In one embodiment, a vacuum is placed near the target area to collect ablated material.

In one embodiment, the present invention includes a process of cleaning a superficial substance off a substrate without damaging the underlying substrate. This process is highly modular and operable to accommodate a wide range superficial material and substrates. In one embodiment, this process is conducted prior to laser ablation. In one embodiment, this process is conducted in order to understand the proper laser parameters for the cleaning job. In one embodiment, this process is operable with any laser ablation system and/or the presently described laser ablation system.

Initially, an inspection of the corrosion and substrate is undertaken to determine the proper frequency, wattage, and/or pattern of laser needed to cleaning the corrosion without damaging the substrate. In one embodiment, a higher wattage and/or stronger laser pattern (e.g., straight line, circle, etc.) is utilized to remove sturdier corrosion and/or difficult to remove superficial material. In one embodiment, a lower wattage and/or gentler laser pattern (e.g., Celtic cross, double oval, etc.) is utilized for easy to remove corrosion and or easy to remove superficial material. In one embodiment, the lower wattage and/or gentler laser pattern is utilized for a more fragile substrate (e.g., painting, injection molding, etc.). In one embodiment, the frequency of the substrate is determined and a matching (i.e., the same or similar) laser frequency is utilized.

Following, the laser is activated and a determination is made as to how much of the superficial material is removed from the substrate on each pass (i.e., movement of the laser beam over the surface of the material to be cleaned). Then, this determination is utilized to fully clean the targeted material, by passing over the substrate the number of times necessary to adequately clean the substrate.

In one embodiment, the laser beam is applied with the laser wand in a repeated stroke or stroking manner without damaging the substrate. The stroke motion causes the laser beam to not be focused on one area of a material for an extended period of time, which could be damaging to the substrate. Rather, the stroke motions used with the method of the present invention provide for gradually removing a superficial layer or gradually cleaning the substrate by removing a portion of the superficial layer or contaminant from the substrate with each stroke across a given area of the substrate. By way of example and not limitation, approximately 10% of the superficial layer or contaminant is removed in a first vertical upstroke movement of the laser wand across the surface of a substrate, approximately 10% of the superficial layer or contaminant is removed in a second vertical downstroke movement of the laser wand across the surface of the substrate, and so on until the entirety or substantially the entirety of the superficial layer or contaminant is removed from the substrate using multiple stroking motions or passes of the laser via the laser wand over a surface of the substrate. Horizontal stroke motions of the laser wand are operable to be used individually or in combination with vertical stroke motions of the laser wand. In this embodiment, the laser beam is applied over the substrate until the substance sought to be removed is removed (e.g., rust, dirt, dust, paint, sludge, coating, or other unwanted substance). In one embodiment, the laser beam is applied in a variety of stroking manners, including by not limited to, freehand, uniform, organized, dabbed, pointed, slow, fast, long, short, quick, random, unsystematic, repeated, discriminate, indiscriminate, planned, intentional, unintentional, overlaid, repeated, and/or deliberate, as to remove the unwanted substance. In one embodiment, the laser beam is applied in any of or any combination of the described stroking motions.

In one embodiment, the present invention is operable to remove rust from a metal substrate, oil or grease from a substrate, paint, oxide, or other coating from a substrate, weld joint cleaning, injection mold cleaning, turbine cleaning, oil painting cleaning, ink removal, clean concrete and masonry, mold/mildew from a substrate, and/or carbon buildup such as soot from a substrate. By using geometric patterns instead of a straight line or linear laser, the present invention provides for cleaning of a variety of surfaces of a variety of undesirable contaminants or layers without damaging the object or substrate.

In one embodiment, the present invention is operable to utilize the systems, apparatus, and methods described in the following listed references, including the laser medium, laser amplifying system, laser wands, and/or cooling systems: U.S. Pat. Nos. 5,780,806, 6,794,602, 6,693,255, CN Patent No. 207,447,601, CN Patent No. 207,447,646, CN Patent No. 112,589,269, CN Patent No. 112,643,202, CN Patent No. 207,447,644, CN Patent No. 207,447,630, CN Patent No. 207,447,645, CN Patent No. 207,337,600, CN Patent No. 207,447,602, CN Patent No. 208,644,377, CN Patent No. 208,853,929, WIPO Patent Publication No. 2022/147688, WIPO Patent Publication No. 2022/133840, CN Patent No. 218,694,699, CN Patent No. 219,093,982 all of which are hereby incorporated by reference in their entirety.

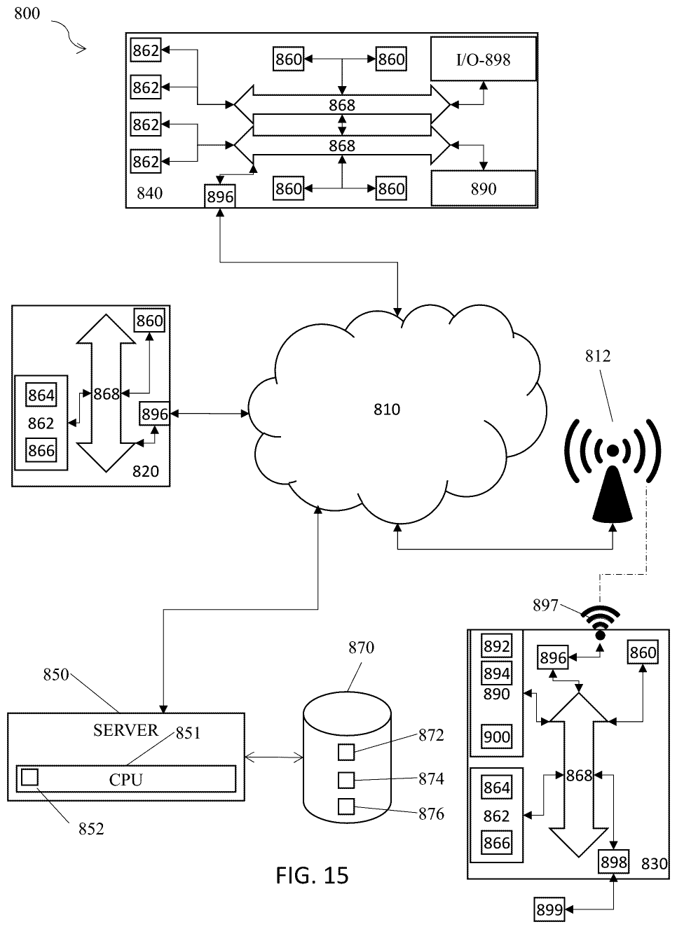

FIG. 15 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 15, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 15, is operable to include other components that are not explicitly shown in FIG. 15, or is operable to utilize an architecture completely different than that shown in FIG. 15. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Location data is created in the present invention using one or more hardware and/or software components. By way of example and not limitation, location data is created using the Global Positioning System (GPS), low energy BLUETOOTH based systems such as beacons, wireless networks such as WIFI, Radio Frequency (RF) including RF Identification (RFID), Near Field Communication (NFC), magnetic positioning, and/or cellular triangulation. By way of example, location data is determined via an Internet Protocol (IP) address of a device connected to a wireless network. A wireless router is also operable to determine identities of devices connected to the wireless network through the router, and thus is operable to determine the locations of these devices through their presence in the connection range of the wireless router.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A method of laser ablation-based cleaning, comprising:
tuning a frequency and/or power of a laser wand based on a material for a corrosion-laden substrate to be cleaned;
selecting a pattern to be emitted from the laser wand, wherein the pattern is not linear;
aiming the laser wand at the substrate; and
activating the laser wand to emit a laser at the substrate, thereby cleaning the substrate;
wherein the substrate is not damaged by the cleaning.

2. The method of claim 1, wherein the frequency and/or power of the laser wand are adjusted via user input on a control board on a laser ablation system chassis.

3. The method of claim 1, wherein the pattern includes an infinity symbol, a flower, a circle, and/or a square.

4. The method of claim 1, wherein the laser wand is air cooled.

5. The method of claim 4, wherein air is transported to the laser wand via an air compressor within a laser ablation system chassis.

6. The method of claim 1, wherein the laser wand causes the pattern to automatically rotate while the laser wand is activated.

7. The method of claim 1, wherein the laser wand emits a continuous wave laser.

8. The method of claim 1, wherein the laser wand operates at a power of approximately 2000 W.

9. A method of laser ablation-based cleaning, comprising:
tuning a frequency and/or power of a laser wand based on a material for a substrate to be cleaned;
selecting a pattern to be emitted from the laser wand;
aiming the laser wand at the substrate; and
activating the laser wand to emit a laser at the substrate, thereby cleaning the substrate;
wherein the laser wand emits a pulsed wave laser at a power of approximately 2000 W.

10. The method of claim 9, wherein the frequency and/or power of the laser wand are adjusted via user input on a control board on a laser ablation system chassis.

11. The method of claim 9, wherein the pattern includes an infinity symbol, a flower, a circle, and/or a square.

12. The method of claim 9, wherein the laser wand is air cooled.

13. The method of claim 12, wherein air is transported to the laser wand via an air compressor within a laser ablation system chassis.

14. The method of claim 9, wherein the laser wand causes the pattern to automatically rotate while the laser wand is activated.

15. A laser ablation apparatus comprising:
a laser ablation housing including an air compressor within the housing;
a laser wand;
a cooling system;
wherein the laser ablation housing houses the cooling system;
wherein the cooling system is operable to cool the laser wand;
wherein the laser wand is operable to emit a laser beam in various patterns; and
wherein the laser ablation system is operable to ablate a substance off a substrate without damaging the substrate.

16. The laser ablation apparatus of claim 15, wherein the various patterns include an infinity symbol, a flower, a circle, and/or a square.

17. The laser ablation apparatus of claim 15, wherein the frequency and/or power of the laser wand are operable to be adjusted via user input on a control board on the laser ablation housing.

18. The laser ablation apparatus of claim 15, wherein the cooling system is an air-cooling system.

19. The laser ablation apparatus of claim 15, wherein the laser wand causes the various patterns to automatically rotate while the laser wand is activated.

20. The laser ablation apparatus of claim 15, wherein the laser wand operates at a power of approximately 2000 W.
